(19) United States
(12) Patent Application Publication
(10) Pub. No.: US 2024/0357262 A1
(43) Pub. Date: Oct. 24, 2024

(54) PHOTOELECTRIC CONVERSION APPARATUS, METHOD FOR DRIVING PHOTOELECTRIC CONVERSION APPARATUS, AND DEVICE

(71) Applicant: CANON KABUSHIKI KAISHA, Tokyo (JP)

(72) Inventor: DAISUKE KOBAYASHI, Kanagawa (JP)

(21) Appl. No.: 18/636,050

(22) Filed: Apr. 15, 2024

(30) Foreign Application Priority Data
Apr. 18, 2023 (JP) 2023-067788

(51) Int. Cl. H04N 25/78; H04N 23/63; H04N 25/65; H04N 25/76

(52) U.S. Cl. CPC H04N 25/78; H04N 23/63; H04N 25/65; H04N 25/7795

(57) ABSTRACT

A photoelectric conversion apparatus includes a pixel configured to generate a pixel signal, a gain setting circuit capable of setting gains for the pixel signal, and a comparator configured to compare a signal output from the gain setting circuit and a ramp signal. A method for driving the photoelectric conversion apparatus includes performing a first step and performing a second step. The first step includes setting one of the gains to a first gain or a second gain based on a first result of comparison made between a signal voltage value of a signal processed with the first gain and a first voltage value. The second step includes setting a gradient of the ramp signal based on a second result of comparison made between a signal voltage value of a signal processed with the first or second gain set in the first step and a second voltage value.

### BACKGROUND

### Field

One disclosed aspect of the embodiments relates to a photoelectric conversion apparatus, a method for driving a photoelectric conversion apparatus, and a device.

### Description of the Related Art

Photoelectric conversion apparatuses desirably have performance, such as a low noise level, a wide dynamic range, and high-speed readout for an improved signal-to-noise (S/N) ratio. In view of such demands, Japanese Patent Application Laid-Open No. 2019-140650 discusses a technique for switching methods for processing pixel signals output from pixels depending on the camera's International Organization for Standardization (ISO) speed setting.

Japanese Patent Application Laid-Open No. 2019-140650 discusses a technique where if the camera's ISO speed setting is low, the signal output levels of the pixel signals output from the pixels are determined to switch the gain of the column amplifiers before analog-to-digital (AD) conversion with a fixed AD conversion gain regardless of the switched gain of the column amplifiers.

However, a photoelectric conversion apparatus including column amplifiers and AD conversion units such as discussed in Japanese Patent Application Laid-Open No. 2019-140650 has room for improvement in the optimization of the operation of the column amplifier gain and the AD conversion gain.

### SUMMARY

One aspect of the embodiments is directed to driving a photoelectric conversion apparatus capable of improving the operation of the column amplifier gain and the AD conversion gain.

According to an aspect of the disclosure, a photoelectric conversion apparatus includes at least one pixel, a gain setting circuit, and a comparator. The at least one pixel is configured to generate a pixel signal by photoelectric conversion. The gain setting circuit is configured to process the pixel signal output from the at least one pixel with a plurality of gains. The comparator is configured to compare a signal output from the gain setting circuit and a ramp signal. According to an aspect of the disclosure, a method for driving the photoelectric conversion apparatus includes setting a gain and setting a gradient. Setting the gain includes setting the gain of the plurality of gains to a first gain or a second gain different from the first gain based on a first result of comparison made between a signal voltage value of the signal processed with the first gain and a first voltage value by the comparator. Setting the gradient includes setting the gradient of the ramp signal based on a second result of comparison made between a signal voltage value of the signal processed with the set first or second gain and a second voltage value by the comparator.

Further features of the disclosure will become apparent from the following description of exemplary embodiments with reference to the attached drawings.

### BRIEF DESCRIPTION OF THE DRAWINGS

FIG. 1 is a block diagram for describing a photoelectric conversion apparatus according to a first exemplary embodiment.

FIG. 2 is a circuit diagram for describing the photoelectric conversion apparatus according to the first exemplary embodiment.

FIG. 3 is a block diagram for describing the photoelectric conversion apparatus according to the first exemplary embodiment.

FIG. 4 is a driving timing chart for describing the photoelectric conversion apparatus according to the first exemplary embodiment.

FIG. 5 is a flowchart for describing the photoelectric conversion apparatus according to the first exemplary embodiment.

FIG. 6 is a chart for describing correction processing by the photoelectric conversion apparatus according to the first exemplary embodiment.

FIG. 7 is a chart for describing the correction processing by the photoelectric conversion apparatus according to the first exemplary embodiment.

FIG. 8 is a diagram for describing the correction processing by the photoelectric conversion apparatus according to the first exemplary embodiment.

FIG. 9 is a block diagram for describing a photoelectric conversion apparatus according to a modification of the first exemplary embodiment.

FIG. 10 is a circuit diagram for describing a photoelectric conversion apparatus according to a second exemplary embodiment.

FIG. 11 is a block diagram for describing a photoelectric conversion apparatus according to a third exemplary embodiment.

FIG. 12 is a circuit diagram for describing a photoelectric conversion apparatus according to a fourth exemplary embodiment.

FIG. 13 is a driving timing chart for describing the photoelectric conversion apparatus according to the fourth exemplary embodiment.

FIG. 14 is a flowchart for describing the photoelectric conversion apparatus according to the fourth exemplary embodiment.

FIGS. 15A to 15C are schematic diagrams for describing devices according to a fifth exemplary embodiment.

### DESCRIPTION OF THE EMBODIMENTS

Exemplary embodiments will be described with reference to the drawings. The following exemplary embodiments are not intended to limit the disclosure set forth in the claims. While a plurality of features is described in the exemplary embodiments, all the plurality of features is not necessarily essential to the disclosure, and the features can be freely combined. In the attached drawings, the same or similar components are denoted by the same reference numerals, and the redundant descriptions thereof will be omitted. In each of the following exemplary embodiments, an imaging sensor will be mainly described as an example of a photoelectric conversion apparatus. However, the exemplary embodiments are not limited to imaging sensors and can be applied to other examples of photoelectric conversion apparatuses. Examples include an imaging apparatus, a ranging apparatus (distance measurement apparatus using focus detection or time of flight [ToF]), and a light metering apparatus (apparatus for measuring the amount of incident light).

As employed herein, terms indicating specific directions or positions (such as “up”, “down”, “right”, “left”, and other terms including these) are used as appropriate. These terms are used to facilitate the understanding of the exemplary embodiments with reference to the drawings, and the technical scope of the disclosure is not limited by the meanings of the terms.

As employed herein, the phrase “member A and member B are electrically connected” is not limited to the case where member A and member B are directly connected. For example, member A and member B can be electrically connected with another member C therebetween.

Metal members, such as wiring and pads described in this specification, may be made of a single-element metal or a mixture (alloy). For example, wiring described as copper wiring may be made only of copper, or consist mainly of copper and contain other components as well. For example, a pad connected to an external terminal may be made only of aluminum, or consist mainly of aluminum and contain other components as well. The copper wiring and the aluminum pad mentioned above are just examples, and may be replaced with various metals. The wiring and the pad mentioned above are examples of metal members used in a photoelectric conversion apparatus, and other metal members are also applicable.

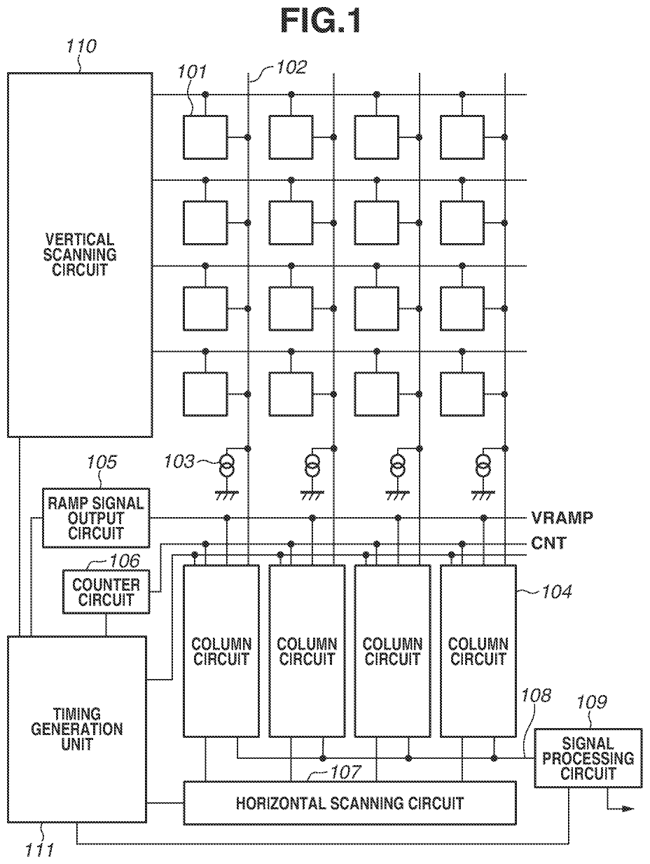

A photoelectric conversion apparatus according to a first exemplary embodiment of the disclosure will be described with reference to FIGS. 1 to 9.

FIG. 1 is an example of a block diagram of the photoelectric conversion apparatus according to the present exemplary embodiment.

As illustrated in FIG. 1, the photoelectric conversion apparatus includes a plurality of pixels 101 arranged in a matrix. While FIG. 1 illustrates 16 pixels 101 arranged in four rows and four columns as an example, the actual photoelectric conversion apparatus includes an array of several tens of millions of pixels 101. This photoelectric conversion apparatus is a complementary metal-oxide-semiconductor (CMOS) image sensor. The present exemplary embodiment is applicable to both front side illuminated and back side illuminated sensors.

Each pixel 101 includes a photoelectric conversion unit for generating a charge by photoelectric conversion, and converts the charge generated by the photoelectric conversion unit into a voltage signal and outputs the voltage signal to a vertical output line 102. In other words, the pixels 101 generate pixel signals by photoelectric conversion, and output the generated pixel signals to the vertical output lines 102. The vertical output lines 102 are output lines each connected to a plurality of pixels 101 arranged in a vertical direction. However, the vertical output lines 102 may be output lines each connected to a plurality of pixels 101 arranged in a horizontal direction. Current sources 103 are electrically connected to the vertical output lines 102 and supply currents to the vertical output lines 102. Column circuits 104 are each arranged for a corresponding column of the respective columns of pixels 101. The pixel signals output from the pixels 101 are input to the column circuits 104 via the vertical output lines 102. The column circuits 104 are analog-to-digital (AD) conversion units that amplify the pixel signals and perform AD conversion. A ramp signal output circuit 105 is a ramp signal supply unit for outputting a ramp signal VRAMP for use in the AD conversion performed by the column circuits 104. The ramp signal output circuit 105 may generate the ramp signal VRAMP. A circuit different from the ramp signal output circuit 105 may generate the ramp signal VRAMP. The ramp signal VRAMP is a signal that changes in voltage over time. In the present exemplary embodiment, a ramp signal VRAMP having a constant gradient (amount of voltage change per unit time) is used, whereas a ramp signal VRAMP with a changing gradient may be used. Examples of the ramp signal VRAMP with a changing gradient include one whose gradient changes stepwise. The ramp signal output circuit 105 can output a plurality of types of ramp signals VRAMP with different gradients. The column circuits 104 can switch the AD conversion gain by switching the plurality of types of ramp signals VRAMP with different gradients. The higher the gradient of a ramp signal VRAMP is, the lower the AD conversion gain is.

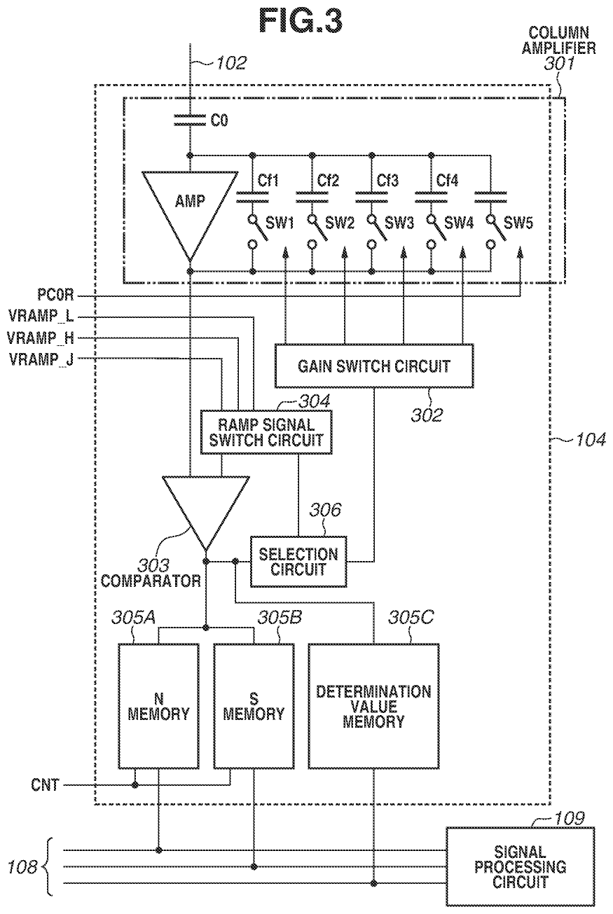

A counter circuit 106 outputs a count signal CNT for use in the AD conversion performed by the column circuits 104. The count signal CNT is a signal for starting to count a clock pulse signal CLK supplied from a not-illustrated clock pulse supply unit when the ramp signal VRAMP of the ramp signal output circuit 105 starts a time-dependent change. While the counter circuit 106 illustrated in FIG. 1 is shared by the column circuits 104, counter circuits 106 may be each arranged for the corresponding column circuit 104 of the column circuits 104. With the counter circuits 106 each arranged for the corresponding column circuit 104 of the column circuits 104, each counter circuit 106 is located between the output terminal of a comparator 303 and the input terminal of an N memory 305A (see FIG. 3), for example. With the counter circuits 106 each arranged for the corresponding column circuit 104 of the column circuits 104, counter memories each corresponding to the corresponding counter circuit 106 of the counter circuits 106 may be provided. The signals AD-converted by the column circuits 104 are sequentially output to outside the photoelectric conversion apparatus via horizontal output lines 108 and a signal processing circuit 109 by a horizontal scanning circuit 107. A vertical scanning circuit 110 performs an operation for sequentially selecting predetermined rows. A timing generation unit 111 supplies driving signals to the vertical scanning circuit 110, the horizontal scanning circuit 107, the column circuits 104, the ramp signal output circuit 105, and the counter circuit 106.

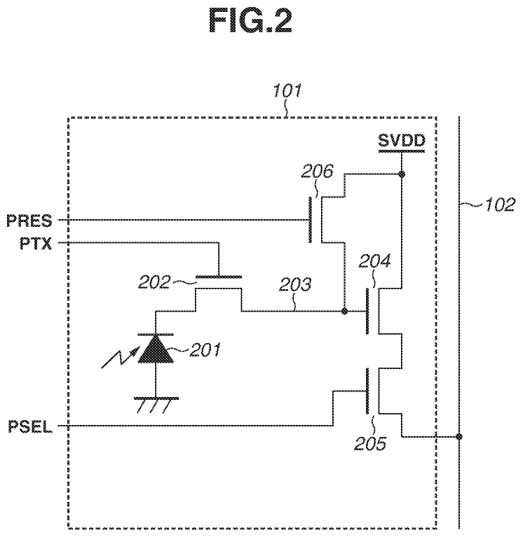

FIG. 2 is an example of a circuit diagram of each pixel 101 included in the photoelectric conversion apparatus according to the present exemplary embodiment.

In the pixel 101, a photoelectric conversion unit 201 converts incident light into a charge and accumulates the charge. Here, a photodiode is illustrated as an example. A transfer metal-oxide-semiconductor (MOS) transistor 202 transfers the charge accumulated in the photoelectric conversion unit 201 to a floating diffusion (FD) 203. The FD 203 converts the transferred charge into a voltage. If a selection MOS transistor 205 is turned on, an amplification MOS transistor 204 amplifies the voltage signal occurring on the FD 203 and outputs the amplified voltage signal to the vertical output line 102. A reset MOS transistor 206 resets the voltage of the FD 203, and the voltage of the photoelectric conversion unit 201 via the transfer MOS transistor 202, to SVDD. The transfer MOS transistor 202, the reset MOS transistor 206, and the selection MOS transistor 205 are connected to the vertical scanning circuit 110 and controlled by control signals PTX, PRES, and PSEL, respectively.

FIG. 3 is an example of a block diagram of each column circuit 104 included in the photoelectric conversion apparatus according to the present exemplary embodiment. As illustrated in FIG. 3, the pixel signal output from a pixel 101 is input to a column amplifier 301 via the vertical output line 102. A gain switch circuit 302 switches the gain of the column amplifier 301. A ramp signal switch circuit 304 switches the gradient of the ramp signal VRAMP.

A selection circuit 306 controls the gain switch circuit 302 and the ramp signal switch circuit 304.

The column amplifier 301 is a gain setting circuit functioning as an amplification circuit. The column amplifier 301 amplifiers the pixel signal based on the gain setting of the gain switch circuit 302, and outputs the amplified pixel signal to the comparator 303. In other words, the column amplifier 301 can process the pixel signal output from the pixel 101 with a plurality of gains. The column amplifier 301 includes an amplifier AMP, an input capacitor C0, feedback capacitors Cf1, Cf2, Cf3, and Cf4, and switches SW1, SW2, SW3, SW4, and SW5. The switches SW1 to SW4 are controlled by the gain switch circuit 302. The switch SW5 is controlled by a C0 reset pulse PCOR. The gain of the column amplifier 301 is determined by the ratio of the capacitance of an active feedback capacitor or capacitors Cf on the feedback path of the amplifier AMP and the capacitance of the input capacitor C0, or C0/Cf. The gain set for the column amplifier 301 may be an amplifying gain or an attenuating gain. The column amplifier 301 will be regarded as an amplification circuit even if some of the plurality of gains are amplifying gains and the other are attenuating gains. Details of the operation by the gain switch circuit 302 will be described below.

The ramp signal VRAMP supplied from the ramp signal output circuit 105 of FIG. 1 is input to one of the input terminals of the comparator 303 based on the result of selection made by the ramp signal switch circuit 304. The output signal of the column amplifier 301 (hereinafter, may be referred to as a column amplifier output signal AMPOUT) is input to the other input terminal of the comparator 303. Details of the operation by the ramp signal switch circuit 304 will be described below.

The comparator 303 is a comparison circuit. The comparator 303 generates a comparison result signal using the column amplifier output signal AMPOUT input from the column amplifier 301 and the ramp signal VRAMP supplied from the ramp signal output circuit 105, and outputs the comparison result signal to the output node. Specifically, if the voltage of the ramp signal VRAMP is lower than that of the column amplifier output signal AMPOUT, the comparator 303 outputs a low level. If the voltage of the ramp signal VRAMP is higher than that of the column amplifier output signal AMPOUT, the comparator 303 outputs a high level. The relationship of the high and low levels here is just an example, and may be reversed.

The counter circuit 106 outputs the count signal CNT for starting to count the clock pulse signal CLK supplied from the not-illustrated clock pulse supply unit when the ramp signal VRAMP of the ramp signal output circuit 105 starts a time-dependent change. More specifically, the counter circuit 106 counts the clock pulse signal CLK in parallel with the voltage change of the ramp signal VRAMP, and generates and outputs the count signal CNT. The count signal CNT is supplied to both the N memory 305A and an S memory 305B in each column. The N memory 305A and the S memory 305B hold the count signal CNT supplied from the counter circuit 106 based on timing when the signal value of the comparator output supplied from the comparator 303 changes from the low level to the high level.

The N memory 305A stores a digital signal obtained by AD-converting a reset-level signal (hereinafter, N signal) of the FD 203. This digital signal incudes a characteristic variation component specific to each column circuit 104. The S memory 305B stores a digital signal obtained by AD-converting a signal (hereinafter, S signal) that is the N signal of the FD 203 on which the signal of the photoelectric conversion unit 201 is superposed. A determination value memory 305C stores results of comparison made between respective reference voltages (first voltage value VREF1 and second voltage value VREF2) output by the ramp signal output circuit 105 and the column amplifier output signal AMPOUT by the comparator 303 (hereinafter, J signals). The J signals are also input to the selection circuit 306. The selection circuit 306 outputs the J signals, or the results of comparison with the first voltage value VREF1 and the second voltage value VREF2, to the gain switch circuit 302 and the ramp signal switch circuit 304. In the present exemplary embodiment, the ramp signal output circuit 105 outputs signals that change in voltage over time. However, the ramp signal output circuit 105 may output the first voltage value VREF1 and the second voltage value VREF2 that do not change in voltage over time. A circuit different from the ramp signal output circuit 105 may generate or output the foregoing constant-voltage signals. The first voltage value VREF1 and the second voltage value VREF2 may have the same value or different values. Details of the operation by the selection circuit 306 will be described below.

The signals stored in the N memory 305A, the S memory 305B, and the determination value memory 305C are output to the signal processing circuit 109 via the horizontal output lines 108 based on control signals from the horizontal scanning circuit 107. The N signal digitized by the signal processing circuit 109 is subtracted from the digitized S signal, and the resulting signal with a reduced noise component is output. Details of the processing by the signal processing circuit 109 will be described below.

The gain switch circuit 302 and the ramp signal switch circuit 304 are connected to the output node of the comparator 303 via the selection circuit 306. With such a configuration, the gain switch circuit 302 and the ramp signal switch circuit 304 can be said to be electrically connected to the comparator 303.

Elements other than the selection circuit 306 (such as a resistive element, a capacitive element, and a logic circuit) may be disposed on the electrical path between the gain switch circuit 302 and the output node of the comparator 303 and the electrical path between the ramp signal switch circuit 304 and the output node of the comparator 303. The configuration where the gain switch circuit 302 and the ramp signal switch circuit 304 are electrically connected to the output node of the comparator 303 also covers such a case as where electrical elements other than the selection circuit 306 are disposed on the electrical paths. In other words, the electrical connection of the output node of the comparator 303 and the gain switch circuit 302 can be said to refer to a configuration where the signal of the output node of the comparator 303 is input to the gain switch circuit 302. The electrical connection of the output node of the comparator 303 and the ramp signal switch circuit 304 can be said to refer to a configuration where the signal of the output node of the comparator 303 is input to the ramp signal switch circuit 304. The output node of the comparator 303 is also electrically connected to the N memory 305A, the S memory 305B, and the determination value memory 305C. Other elements may also be disposed on the electrical paths between the output node of the comparator 303 and the memories.

The photoelectric conversion apparatus according to the present exemplary embodiment can switch the gain of the column amplifier 301 based on the signal output level of the pixel signal output from the pixel 101 and then perform AD conversion by switching the gradient of the ramp signal VRAMP based on the signal output level of the column amplifier output signal AMPOUT output from the column amplifier 301.

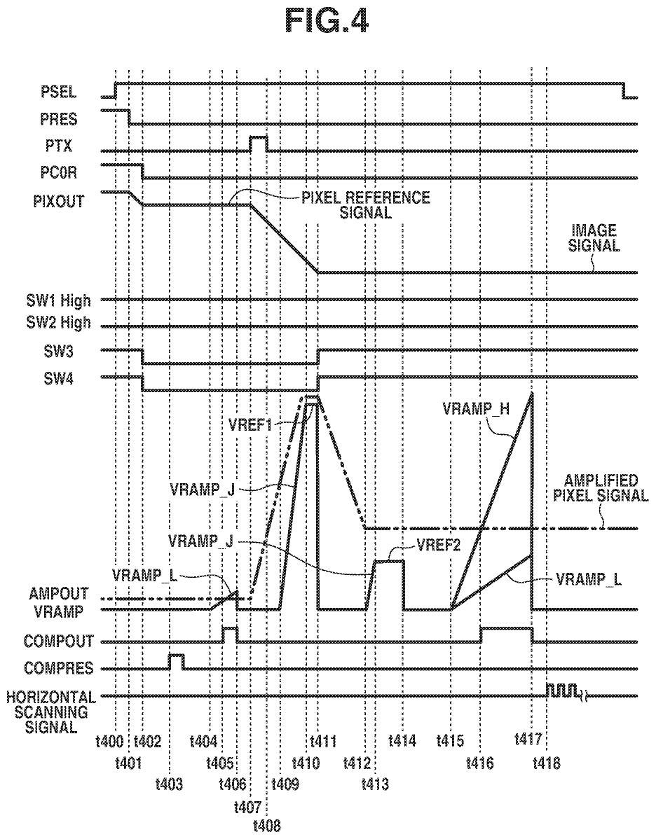

FIG. 4 is an example of a driving timing chart of a charge read operation by the photoelectric conversion apparatus according to the present exemplary embodiment. FIG. 4 schematically illustrates the timings of driving pulses, and a pixel output voltage, a column amplifier output voltage, and the ramp signal VRAMP. A gain-setting period from time t407 to time t411 will be referred to as a first step. The period from time t412 to time t414 where the gradient of the ramp signal VRAMP is set will be referred to as a second step. The period from time t415 to time t417 where AD conversion is performed will be referred to as a third step. The period from time t404 to time t406 where AD conversion is performed will be referred to as a fourth step. The operation for transferring a charge from the photoelectric conversion unit 201 of each pixel 101 is performed at a plurality of timings. The first and second steps may be both performed between two consecutive ones of the plurality of timings. At least one of the third and fourth steps may be performed in addition to the first and second steps between the two consecutive ones of the plurality of timings. That the operation for transferring a charge from the photoelectric conversion unit 201 of the pixel 101 is performed at a plurality of timings covers a case where the operation is performed once in each of a plurality of frames, for example. That the operation for transferring a charge from the photoelectric conversion unit 201 of the pixel 101 is performed at a plurality of timings also covers a case where the operation is performed a plurality of times in a frame.

At time t400, the vertical scanning circuit 110 sets the selection pulse PSEL to a high level to select the row of pixels 101 to output pixel signals PIXOUT. The vertical scanning circuit 110 also sets the reset pulse PRES to a high level to reset the voltage of the FDs 203. At time t401, the vertical scanning circuit 110 sets the reset pulse PRES to a low level. A pixel signal PIXOUT output when the reset pulse PRES is at the low level will be referred to as a “pixel reference signal”. The pixel reference signal is a signal containing a noise component of the pixel 101.

At time t402, the timing generation unit 111 changes the C0 reset pulse PCOR from a high level to a low level to end resetting the amplifier AMP and the input capacitor C0. A charge based on the voltage of the pixel reference signal when the C0 reset pulse PCOR is changed to the low level is thereby stored into the input capacitor C0. The column amplifier 301 outputs the column amplifier output signal AMPOUT. At time t403, the timing generation unit 111 sets a comparator reset pulse COMPRES to a high level, and after a predetermined time, to a low level. The comparator reset pulse COMPRES is intended to reset the comparator 303 for initialization.

The gain of the column amplifier 301 is determined by the ratio of the capacitance of the feedback capacitor(s) Cf1, Cf2, Cf3, and/or Cf4 connected to the feedback path of the amplifier AMP and the capacitance of the input capacitor C0. In the present exemplary embodiment, the feedback capacitors Cf1, Cf2, Cf3, and Cf4 have a capacitance ⅛ times, ⅛ times, ¼ times, and ½ times that of the input capacitor C0, respectively. If all the feedback capacitors Cf1, Cf2, Cf3, and Cf4 are used, the gain is 1/(⅛+⅛+¼+½)=1. If only the feedback capacitors Cf1 and Cf2 are used, the gain is 1/(⅛+⅛)=4. The gain combinations are not limited to those of the present exemplary embodiment. The gains may be switched by switching the input capacitor C0 instead of switching the feedback capacitors Cf. Suppose here that the switches SW3 and SW4 are turned off to use only the feedback capacitors Cf1 and Cf2, and the column amplifier 301 outputs the column amplifier output signal AMPOUT with a gain of four times (first gain).

In the period from time t404 to time t406, the ramp signal output circuit 105 increases the voltage of a ramp signal VRAMP_L from its initial value in a time-dependent manner. The ramp signal output circuit 105 can simultaneously output a plurality of ramp signals with different gradients and input the ramp signals to the column circuits 104. For example, the plurality of ramp signals with different gradients includes a ramp signal VRAMP_L with a low gradient, a ramp signal VRAMP_H with a high gradient, and a ramp signal VRAMP_J with an even higher gradient. Further, the gradient of the ramp signal VRAMP_J may be lower than that of the ramp signal VRAMP_H or lower than that of the ramp signal VRAMP_L. Suppose here that the ramp signal VRAMP_L is input to the comparator 303 via the ramp signal switch circuit 304. The use of the ramp signal VRAMP_L as a reference voltage allows high-resolution AD conversion since the amount of voltage change per time is smaller than when the ramp signal VRAMP_H is used. In the period from time t404 to time t406, high-resolution AD conversion is performed using the ramp signal VRAMP_L. Such driving is implemented by the timing generation unit 111 transmitting the control signals to the ramp signal output circuit 105 and the ramp signal switch circuit 304. Suppose that the gradient of the ramp signal VRAMP_L is a first gradient, that of the ramp signal VRAMP_H is a second gradient higher than the first gradient, and that of the ramp signal VRAMP_J is a third gradient higher than the second gradient. In the period from time t404 to time t406, the column amplifier output signal AMPOUT processed with the first gain is compared with the ramp signal VRAMP having the first gradient or the second gradient. The column amplifier output signal AMPOUT processed with the first gain, which is an analog signal, is then converted into a digital signal based on the result of comparison (hereinafter, referred to as a fourth result of comparison).

At time t404, the ramp signal output circuit 105 starts to change the voltage of the ramp signal VRAMP_L, and the counter circuit 106 starts to count the clock pulse signal CLK and supplies the count signal CNT to the N memory 305A in each column. At time t405, the voltage of the ramp signal VRAMP_L exceeds the column amplifier output signal AMPOUT, and the signal value of a comparator output COMPOUT output by the comparator 303 changes. The value (count value) of the count signal CNT here is stored in the N memory 305A. The value of the count signal CNT stored in the N memory 305A here is a digital value obtained by AD-converting the N signal. At time t406, the ramp signal output circuit 105 stops changing the voltage of the ramp signal VRAMP_L in a time-dependent manner, and resets the ramp signal VRAMP_L to the state of time t400. The counter circuit 106 stops counting the clock pulse signal CLK, and resets the count signal CNT to the initial value.

At time t407, the vertical scanning circuit 110 sets the transfer pulse PTX to a high level. At time t408, the vertical scanning circuit 110 sets the transfer pulse PTX to a low level. The charge generated by the light incident on the photoelectric conversion unit 201 is thereby transferred to the FD 203. The amplification MOS transistor 204 outputs the voltage signal based on the charge transferred to the FD 203. This voltage signal is output to the vertical output line 102 via the selection MOS transistor 205. The output signal is an image signal that is a kind of pixel signal PIXOUT. The image signal is an analog signal having a voltage corresponding to the amount of light received by the photoelectric conversion unit 201 in one frame period.

The column amplifier 301 outputs a column amplifier output signal AMPOUT obtained by inverting and amplifying a voltage difference between the pixel reference signal and the image signal. The column amplifier output signal AMPOUT here will be referred to as an “amplified image signal”. The amplified image signal is input to one of the input terminals of the comparator 303. The column amplifier 301 may output a column amplifier output signal AMPOUT obtained by inverting and amplifying the image signal.

The amplified image signal, as well as the column amplifier output signal AMPOUT obtained by inverting and amplifying the image signal, is handled as an S signal in the signal processing at the stages subsequent to the column amplifier 301.

In the period from time t409 to time t411, the ramp signal VRAMP_J is input to the other input terminal of the comparator 303. The ramp signal VRAMP_J is output by the ramp signal output circuit 105 and input to the comparator 303 via the ramp signal switch circuit 304.

In the period from time t409 to time t410, the ramp signal output circuit 105 increases the voltage of the ramp signal VRAMP_J from its initial value in a time-dependent manner. At time t410, the ramp signal output circuit 105 stops changing the voltage of the ramp signal VRAMP_J. The voltage of the ramp signal VRAMP_J at time t410 is the first voltage value VREF1. The first voltage value VREF1 is used as a threshold for determining whether the column amplifier output signal AMPOUT exceeds the input range of AD conversion.

In the period from time t410 to time t411, the comparator 303 compares the first voltage value VREF1 and the column amplifier output signal AMPOUT processed with the first gain. If the voltage of the column amplifier output signal AMPOUT is lower than the first voltage value VREF1, the comparator output COMPOUT (first J signal) changes from the low level to a high level (=1). The comparator output COMPOUT based on a first result of comparison between the first voltage value VREF1 and the column amplifier output signal AMPOUT is input to the selection circuit 306. The selection circuit 306 outputs a switch signal to the gain switch circuit 302. The gain switch circuit 302 inputs a gain switch signal to the column amplifier 301. If the voltage of the column amplifier output signal AMPOUT processed with the first gain is lower than the first voltage value VREF1, the switches SW1 to SW4 remain unchanged and the gain is maintained at four times (first gain). In other words, in the first step, the gain is set to the first gain (four times) based on the first result.

If the voltage of the column amplifier output signal AMPOUT is higher than the first voltage value VREF1, the comparator output COMPOUT (first J signal) changes to the low level (=0). The comparator output COMPOUT based on such a first result of comparison between the first voltage value VREF1 and the column amplifier output signal AMPOUT processed with the first gain is input to the selection circuit 306. The selection circuit 306 outputs a switch signal to the gain switch circuit 302. The gain switch circuit 302 inputs a gain switch signal to the column amplifier 301. If the voltage of the column amplifier output signal AMPOUT processed with the first gain is higher than the first voltage value VREF1, the switches SW3 and SW4 are turned on to set the gain to 1 (second gain different from the first gain). In other words, in the first step, the setting of the first gain (four times; hereinafter, may be referred to as 4×) is switched to the second gain (1×) based on the first result.

In the period from time t410 to time t411, the value of the comparator output COMPOUT (first determination value J1) is input to the selection circuit 306. The first determination value J1 is also stored into the determination value memory 305C. FIG. 4 illustrates an example where the column amplifier output signal AMPOUT is higher than VREF1 and the gain is switched from 4× to 1×. At time t411, the determination as to which gain of the column amplifier 301 to use in the S signal AD conversion period, 1× or 4×, ends. The ramp signal output circuit 105 resets the voltage of the ramp signal VRAMP_J.

In the period from time t412 to time t413, the ramp signal output circuit 105 increases the voltage of the ramp signal VRAMP_J from its initial value in a time-dependent manner. At time t413, the ramp signal output circuit 105 stops changing the voltage of the ramp signal VRAMP_J. The voltage of the ramp signal VRAMP_J at time t413 is the second voltage value VREF2. This second voltage value VREF2 is used as a threshold for determining which to select as the ramp signal for AD-converting the column amplifier output signal AMPOUT, the ramp signal VRAMP_L or the ramp signal VRAMP_H.

In the period from time t413 to time t414, the comparator 303 compares the second voltage value VREF2 and the column amplifier output signal AMPOUT processed with the first or second gain set in the first step. In the present exemplary embodiment illustrated in FIG. 4, the column amplifier output signal AMPOUT is processed with the second gain based on the first result of the first step. If the voltage of the column amplifier output signal AMPOUT is lower than the second voltage value VREF2, the comparative output COMPOUT (second J signal) changes from the low level to the high level (=1). The comparator output COMPOUT based on a second result of comparison between the second voltage value VREF2 and the column amplifier output signal AMPOUT processed with the second gain is input to the selection circuit 306. The selection circuit 306 outputs a switch signal to the ramp signal switch circuit 304. The ramp signal switch circuit 304 selects the ramp signal VRAMP_L and inputs the ramp signal VRAMP_L to the comparator 303. If the voltage of the column amplifier output signal AMPOUT processed with the second gain is lower than the second voltage value VREF2, the ramp signal VRAMP_L with the low gradient is used for AD conversion. In other words, in the second step, the first gradient (high AD conversion gain) lower than the second gradient (low AD conversion gain) is set based on the second result.

If the voltage of the column amplifier output signal AMPOUT is higher than the second voltage value VREF2, the comparator output COMPOUT (second J signal) is at the low level (=0). The comparator output COMPOUT based on the second result of comparison between the second voltage value VREF2 and the column amplifier output signal AMPOUT processed with the second gain is input to the selection circuit 306. The selection circuit 306 outputs a switch signal to the ramp signal switch circuit 304. The ramp signal switch circuit 304 selects the ramp signal VRAMP_H and inputs the ramp signal VRAMP_H to the comparator 303. If the voltage of the column amplifier output signal AMPOUT processed with the second gain is higher than the second voltage value VREF2, the ramp signal VRAMP_H with the higher gradient than that of the ramp signal VRAMP_L is used for AD conversion. In other words, in the second step, the second gradient (low AD conversion gain) higher than the first gradient (high AD conversion gain) is set based on the second result.

By the foregoing driving method, AD conversion can be performed with appropriate resolution based on the signal output level of the column amplifier output signal AMPOUT processed with the second gain, without exceeding the AD conversion input range. In other words, both the resolution and the frame rate can be improved in a compatible manner.

In the period from time t413 to time t414, the value of the comparator output COMPOUT (second determination value J2) is input to the selection circuit 306. The second determination value J2 is also stored into the determination value memory 305C. Here, the second determination value J2 is stored in the determination value memory 305C aside from the first determination value J1. The determination value memory 305C stores the first and second determination values J1 and J2 in respective separate bits. At time t414, the determination as to which signal to use in the S signal AD conversion period, the ramp signal VRAMP_H or VRAMP_L, ends. The ramp signal output circuit 105 resets the voltage of the ramp signal VRAMP_J.

In the period from time t415 to time t417, the ramp signal output circuit 105 increases the voltage of the ramp signal VRAMP_L or VRAMP_H from its initial value in a time-dependent manner. The column amplifier output signal AMPOUT processed with the first or second gain is then compared with the ramp signal VRAMP having the first or second gradient. The column amplifier output signal AMPOUT processed with the first or second gain, which is an analog signal, is converted into a digital signal based on the result of comparison (hereinafter, referred to as a third result of comparison). Which ramp signal for each column circuit 104 to input to its comparator 303, VRAMP_L or VRAMP_H, is determined based on the value of the comparator output COMPOUT between time t413 and time t414. In the case of FIG. 4, the column amplifier output signal AMPOUT in the period from time t413 to time t414 is higher than the second voltage value VREF2, and the ramp signal VRAMP_H with the higher gradient, or second gradient, is thus selected.

At time t415, the ramp signal output circuit 105 starts to change the voltage of the ramp signal VRAMP_H. The counter circuit 106 starts to count the clock pulse signal CLK and supplies the count signal CNT to the S memory 305B in each column.

At time t416, the voltage of the ramp signal VRAMP_H exceeds the column amplifier output signal AMPOUT, and the signal value of the comparator output COMPOUT changes. The value (count value) of the count signal CNT here is stored in the S memory 305B. The value of the count signal CNT stored in the S memory 305B here is a digital value obtained by AD-converting the S signal.

At time t417, the ramp signal output circuit 105 stops changing the voltage of the ramp signal VRAMP_L or VRAMP_H in a time-dependent manner, and resets the ramp signal VRAMP_L or VRAMP_H to the state of time t400. The counter circuit 106 stops counting the clock pulse signal CLK and restores the count signal CNT to its initial value.

At and after time t418, the horizontal scanning circuit 107 sequentially operates the column circuits 104, whereby the signals stored in the N memory 305A, the S memory 305B, and the determination value memory 305C in each column circuit 104 are transmitted to the signal processing circuit 109 via the horizontal output lines 108. After calculation processing, the signals are output to outside the photoelectric conversion apparatus.

The signal processing circuit 109 calculates a differential signal level (light component) by subtracting the digitized N signal from the digitized S signal. Before the calculation of the S signal minus the N signal, the AD conversion result of the S signal is corrected using the ramp signal selected in AD-converting the S signal. The processing for correcting the AD conversion result will now be described. For example, if the gradient of the ramp signal VRAMP_H is four times that of the ramp signal VRAMP_L, the signal amplitude of the ramp signal VRAMP_H for one count of the count signal CNT is four times. To get accurate results, the count value AD-converted with the ramp signal VRAMP_H is quadrupled using a digital gain. Whether to correct the S signal input to the signal processing circuit 109 can be determined based on the second determination value J2 stored in the determination value memory 305C. If the second determination value J2=0, the processing for quadrupling the S signal is performed since the ramp signal VRAMP_H is selected. On the other hand, if the second determination value J2=1, the processing for quadrupling the S signal is not performed since the ramp signal VRAMP_L is selected. Such processing will be referred to as first correction processing.

The threshold (second voltage value VREF2) for determining the second determination value J2 can be freely set. If the gradient of the ramp signal VRAMP_H is four times that of the ramp signal VRAMP_L, the threshold can be set to ¼ the amplitude of the column amplifier output signal AMPOUT. In other words, the second voltage value VREF2 can be set based on the first gradient and the second gradient. For example, if the maximum amplitude of the column amplifier output signal AMPOUT to be AD-converted is 1 [V], the second voltage value VREF2 is set to a value equivalent to an amplitude of 0.25 [V]. If the AD conversion counter is configured to count in 12 bits, or up to 4095, the ramp signal VRAMP_L is controlled to reach the amplitude of 0.25 [V] in 4095 counts. The ramp signal output circuit 105 is shared by the column circuits 104. If the second voltage value VREF2 is set to the value equivalent to the amplitude of 0.25 [V], the AD conversion range therefore can be inadequate for some of the column circuits 104 because of variations in the plurality of column circuits 104 and constant noise. In such a case, the second voltage value VREF2 can be set to a value equivalent to an amplitude of 0.24 [V], for example. The ramp signal VRAMP_H is then controlled to reach the amplitude of 1 [V] in 4095 counts.

Whether to correct the S signal through the first correction processing based on the gain setting of the column amplifier 301 can be determined from the first determination value J1 stored in the determination value memory 305C. If the first determination value J1=0, the S signal through the first correction processing is further quadrupled since the gain of the column amplifier 301 is changed from 4× to 1×. On the other hand, if the first determination value J1=1, the S signal through the first correction processing is not quadrupled since the gain of the column amplifier 301 is not changed from 4×. Such a correction will be referred to as second correction processing. The threshold (first voltage value VREF1) for determining the first determination value J1 can be freely set. The first voltage value VREF1 can be set with reference to the maximum input range of the AD conversion to be performed by the comparator 303. For example, if the maximum amplitude of the column amplifier output signal AMPOUT to be AD-converted is 1 [V], the first voltage value VREF1 can be set to a value equivalent to an amplitude of 1 [V]. If the AD conversion counter is configured to count in 12 bits, or up to 4095, the ramp signal VRAMP_H is controlled to reach the amplitude of 1 [V] in 4095 counts. Taking a margin into account, the first voltage value VREF1 may be set to be less than the maximum value of the ramp signal VRAMP_H.

In the present exemplary embodiment, under high luminance, the column amplifier 301 uses a gain of 1× since optical shot noise occurring in proportion to the amount of light is dominant over circuit noise. In contrast, under low luminance, the column amplifier 301 uses a gain of 4× since the circuit noise is dominant. This relatively reduces the effect of noise occurring from the comparator 303 at the subsequent stage, and a high dynamic range signal with an improved S/N ratio can be obtained. After the gain setting of the column amplifier 301, high-resolution AD conversion can be performed at high speed by selecting an appropriate ramp signal VRAMP_H or VRAMP_L.

In the present exemplary embodiment, for example, a high-resolution signal with favorable noise characteristic can be obtained under low luminance by amplifying the pixel signal PIXOUT and performing AD conversion using the low-gradient ramp signal VRAMP_L. Under high luminance, a signal of enhanced dynamic range can be obtained at high speed by reducing the amplification ratio of the pixel signal PIXOUT and performing AD conversion using the high-gradient ramp signal VRAMP_H.

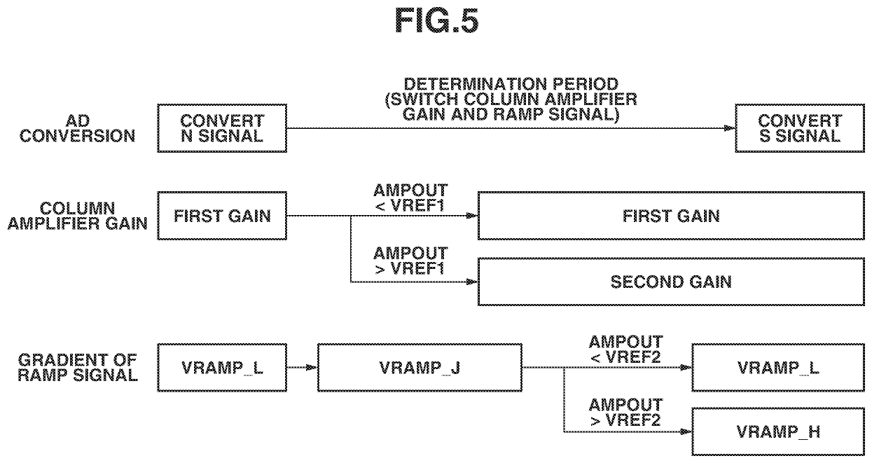

FIG. 5 is a diagram for describing a flowchart of signal processing by the photoelectric conversion apparatus according to the present exemplary embodiment. “AD CONVERSION” illustrated in FIG. 5 indicates the AD conversion period of the N signal, a determination period (setting of the column amplifier gain and the gradient of the ramp signal), and the AD conversion period of the S signal.

In the determination period, the comparator 303 stores the determination values J (first determination value J1 and second determination value J2) based on the results of comparison between the column amplifier output signal AMPOUT and the ramp signal VRAMP_J into the determination value memory 305C. In the determination period, the selection circuit 306 outputs signals to the gain switch circuit 302 and the ramp signal switch circuit 304 to control the gain switching of the column amplifier 301 and the switching of the ramp signal VRAMP. In “COLUMN AMPLIFIER GAIN” illustrated in FIG. 5, the first gain is 4× and the second gain is 1× as described with reference to FIG. 4, for example. In the determination period, the column amplifier output signal AMPOUT is compared with the first voltage value VREF1. If AMPOUT<VREF1, the gain of the column amplifier 301 is maintained at the first gain setting. On the other hand, if AMPOUT>VREF1, the gain of the column amplifier 301 is set to the second gain different from the first gain. “GRADIENT OF RAMP SIGNAL” illustrated in FIG. 5 indicates the gradient of the ramp signal VRAMP input to the comparator 303. For example, during the AD conversion of the N signal, the ramp signal VRAMP_L is input to the comparator 303. During the determination period, the selectin circuit 306 outputs a signal to switch the gain of the column amplifier 301 by the gain switch circuit 302, and the comparator 303 compares the column amplifier output signal AMPOUT and the second voltage value VREF2. If the comparison result indicates that AMPOUT<VREF2, the ramp signal VRAMP_L is selected and the S signal is AD-converted. On the other hand, if the comparison result indicates that AMPOUT>VREF2, the ramp signal VRAMP_H is selected and the S signal is converted. In other words, either the ramp signals VRAMP_L or VRAMP_H is selected for the first gain, and either the ramp signals VRAMP_L or VRAMP_H is selected for the second gain. In the present exemplary embodiment, there are therefore four combinations of the gain of the column amplifier 301 and the gradient of the ramp signal VRAMP. Further, the number of combinations of the gain of the column amplifier 301 and the gradient of the ramp signal VRAMP is not limited to four. The number of combinations depends on the number of gain settings of the column amplifier 301 and the number of gradient settings of the ramp signal VRAMP.

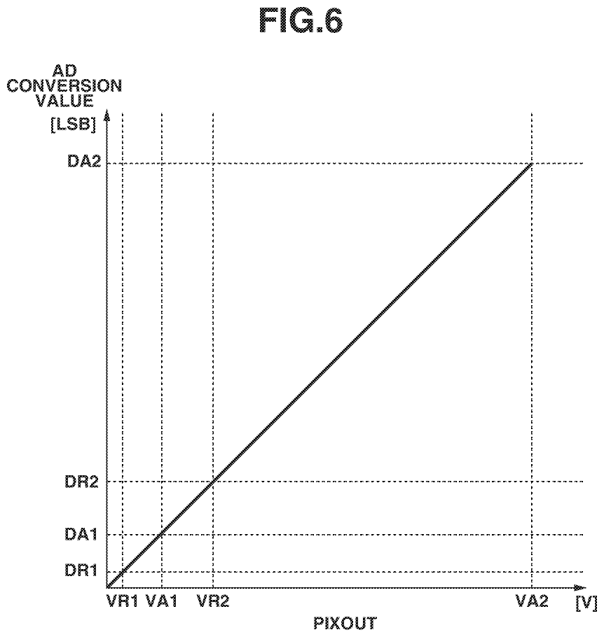

FIG. 6 is a chart for describing the correction processing by the photoelectric conversion apparatus according to the present exemplary embodiment.

Correction processing where the first gain described in FIG. 5 is 8×, the second gain is 1×, and the ratio of the changes in the ramp signals VRAMP_L and VRAMP_H over time is 1:4 will be described with reference to FIG. 6. The horizontal axis of FIG. 6 indicates the range of the amount of incident light, i.e., the signal level [V] of the pixel signal PIXOUT. The vertical axis indicates the corrected digital value (corrected AD conversion value) [LSB]. Here, the maximum value of the pixel signal PIXOUT is denoted by VA2. Since the gain ratio of the column amplifier 301 is 8, the pixel signal PIXOUT is AD-converted with the gain of the column amplifier 301 set to 8× in the signal level range up to VA1 that is ⅛ of VA2, and with the gain of the column amplifier 301 set to 1× in the signal level range beyond VAL. The digital value of VA1 AD-converted with the gain of the column amplifier 301 set to 8× will be denoted by DA1. DA1 is the maximum value of the output range of the AD conversion. The digital value of VA2 AD-converted with the gain of the column amplifier 301 set to 1× is also DA1, whereas the digital value DA1 corrected by the signal processing circuit 109 is eightfold, or DA2. In such a manner, the results of the AD conversion by the column amplifier 301 with different gains are corrected by using the signal processing circuit 109 based on the gain ratio of the column amplifier 301. In such a case, DA1 can be made eight times by shifting DA1 three bits to the left. As for the selection of the ramp signal VRAMP, the ramp signal VRAMP_L is selected for the signal level range of up to ¼ the maximum value and the ramp signal VRAMP_H is selected beyond the signal level range, whether the gain of the column amplifier 301 is 1× or 8×. If the gain of the column amplifier 301 is 8×, the pixel signal PIXOUT up to VR1 is AD-converted using the ramp signal VRAMP_L, and the pixel signal PIXOUT from VR1 to VA1 is AD-converted using the ramp signal VRAMP_H. If the gain of the column amplifier 301 is 1×, the pixel signal PIXOUT up to VR2 is AD-converted using the ramp signal VRAMP_L, and the pixel signal PIXOUT from VR2 to VA2 is AD-converted using the ramp signal VRAMP_H. The digital value of VR1 AD-converted under the condition that the gain of the column amplifier 301 is 8× and the ramp signal VRAMP_L is used will be denoted by DR1. DR1 is the maximum value of the output range of the AD conversion. The digital value of VA1 AD-converted under the condition that the gain of the column amplifier 301 is 8× and the ramp signal VRAMP_H is used is also DR1, whereas the digital value DR1 corrected by the signal processing circuit 109 is fourfold, or DAL. Similarly, the digital value of VR2 AD-converted under the condition that the gain of the column amplifier 301 is 1× and the ramp signal VRAMP_L is used is also DR1. The digital value DR1 corrected by the signal processing circuit 109 is DR2, being multiplied by 8 as the gain ratio of the column amplifier 301.

The signal processing circuit 109 corrects the digital signal based on the set gain ratio of the column amplifier 301 and the gradient ratio of the ramp signals VRAMP. The set gain ratio of the column amplifier 301 and the gradient ratio of the ramp signals VRAMP are, however, subject to error. The error in the ratios can cause errors, such as offsets in the digital signal at points VR1, VA1, VR2, and VA2 of the pixel signal PIXOUT in FIG. 6 and a linearity difference between the range up to VA1 and the range of VA1 to VA2.

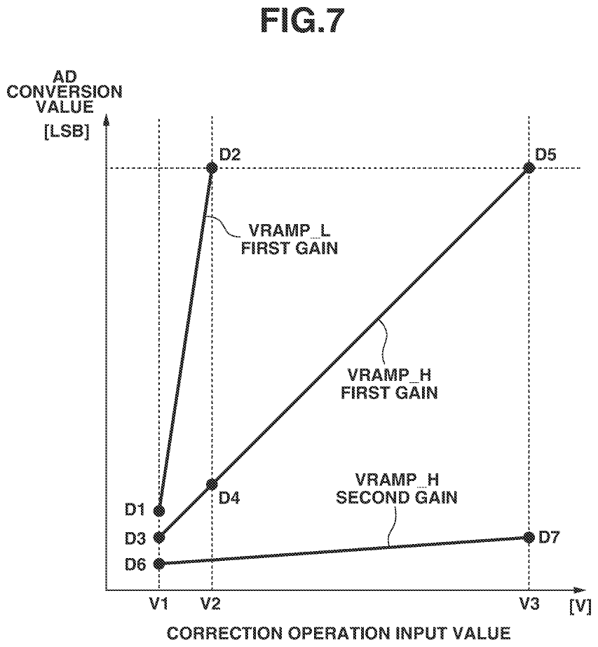

FIG. 7 is a diagram for describing the correction processing by the photoelectric conversion apparatus according to the present exemplary embodiment.

As illustrated in FIG. 7, correction operation input values V1, V2, and V3 are input to a column circuit 104 from a not-illustrated reference voltage source. Here, AD conversion is performed with a predetermined setting, without determining the gain of the column amplifier 301 or the gradient of the ramp signal VRAMP. The digital value obtained from the correction operation input value V1 under the condition of the first gain and the ramp signal VRAMP_L will be denoted by D1. The digital value obtained from the correction operation input value V1 under the condition of the first gain and the ramp signal VRAMP_H will be denoted by D3. The digital value obtained from the correction operation input value V1 under the condition of the second gain and the ramp signal VRAMP_H will be denoted by D6. The digital value obtained from the correction operation input value V2 under the condition of the first gain and the ramp signal VRAMP_L will be denoted by D2. The digital value obtained from the correction operation input value V2 under the condition of the first gain and the ramp signal VRAMP_H will be denoted by D4. The digital value obtained from the correction operation input value V3 under the condition of the first gain and the ramp signal VRAMP_H will be denoted by D5. The digital value obtained from the correction operation input value V3 under the second gain and the ramp signal VRAMP_H will be denoted by D7. For example, the ratio between the gradients of the ramp signals VRAMP_H and VRAMP_L can be calculated from the gradient of the line connecting the digital values D2 and D1 and the gradient of the line connecting the digital values D3 and D4, whereby an error between the actual measurement and the setting values can be obtained. Similarly, the ratio between the first and second gains can be calculated from the gradient of the line connecting the digital values D3 and D5 and the gradient of the line connecting the digital values D6 and D7, whereby an error between the actual measurements and the setting values can be obtained. The value of the AD conversion error in AD-converting the same correction operation input value V2 using the ramp signals VRAMP_L and VRAMP_H can be calculated by comparing the digital values D4 and D2. Similarly, the value of the AD conversion error in AD-converting the same correction operation input value V3 using the first gain and the second gain can be obtained by comparing the digital values D5 and D7. Suppose, for example, that the values of the AD conversion errors are such that the set gain ratio of the column amplifier 301 is 8 and the gain ratio of the column amplifier 301 obtained by the correction processing is 8.1. In such a case, a gain adjustment of 1.25% is made in the correction processing. If there are AD conversion errors, the gains are offset as well. AD conversion results of favorable linearity with the respect to the amount of incident light can thus be obtained by calculating calculation correction values from the digital values obtained by the correction operation and applying the calculation correction values to the correction processing.

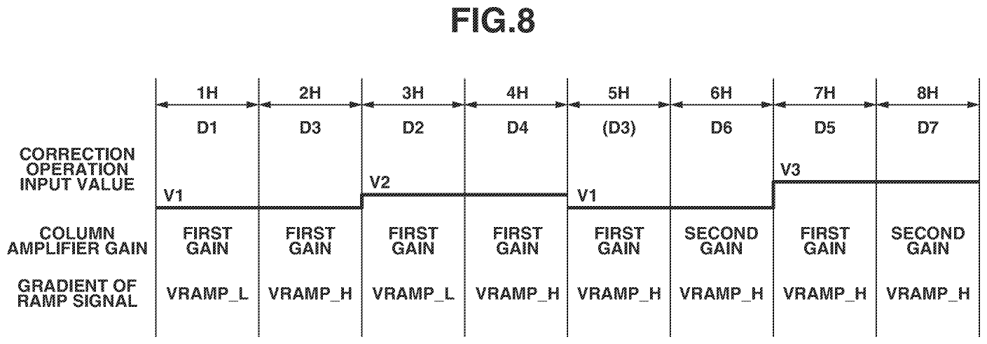

FIG. 8 is a diagram for describing the correction processing by the photoelectric conversion apparatus according to the present exemplary embodiment, a diagram for describing the operation procedure of the correction operation described with reference to FIG. 7. Here, the reading time of a row of pixels 101 among the pixels 101 arranged in the matrix will be denoted by 1H.

FIG. 8 illustrates an example where a correction operation is performed by switching the correction operation input values, the gains of the column amplifiers 301, and the gradients of the ramp signal VRAMP, using the reading times of eight rows 1H to 8H. This correction operation is performed, for example, when a surrounding environment condition, such as temperature, changes, in a calibration period upon power-on, or in a specific period during photoelectric conversion. If the photoelectric conversion apparatus has an optical black area, the correction operation may also be performed in reading part of the optical black area.

In the present exemplary embodiment, AD conversion can be performed by switching the gain of the column amplifier 301 based on the signal output level of the pixel signal PIXOUT output from the pixel 101 and then switching the gradient of the ramp signal VRAMP based on the signal output level of the column amplifier output signal AMPOUT output from the column amplifier 301. The operation of the column amplifier gain and the AD conversion gain can be optimized by such an operation.

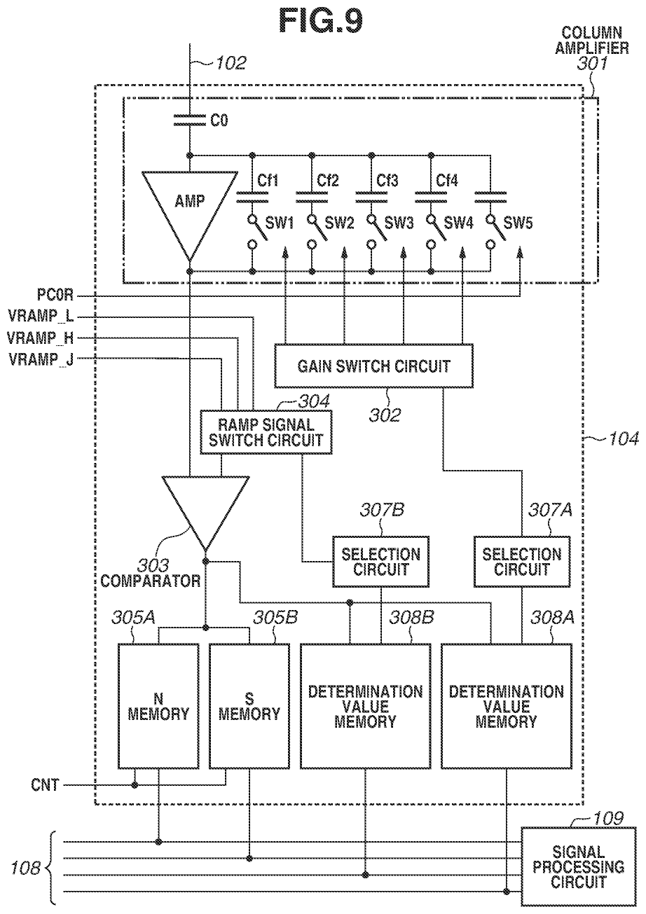

A photoelectric conversion apparatus according to a modification of the first exemplary embodiment of the disclosure will be described with reference to FIG. 9. Similar components to those of the first exemplary embodiment are denoted by the same reference numerals. A description of such components may be omitted or simplified.

The modification of the first exemplary embodiment differs from the first exemplary embodiment in that each column circuit 104 includes a plurality of selection circuits and a plurality of determination value memories. FIG. 9 is an example of a block diagram of a column circuit 104 included in the photoelectric conversion apparatus according to the present exemplary embodiment.

As illustrated in FIG. 9, the column circuit 104 according to this modification is configured by replacing the selection circuit 306 with selection circuits 307A and 307B and replacing the determination value memory 305C with determination value memories 308A and 308B.

The gain switch circuit 302 is connected to the output node of the comparator 303 via the determination value memory 308A and the selection circuit 307A. The gain switch circuit 302 may be connected to the output node of the comparator 303 without the intervention of the determination value memory 308A. The ramp signal switch circuit 304 is connected to the output node of the comparator 303 via the determination value memory 308B and the selection circuit 307B. The ramp signal switch circuit 304 may be connected to the output node of the comparator 303 without the intervention of the determination value memory 308B. In such a configuration, the gain switch circuit 302 and the ramp signal switch circuit 304 can be said to be electrically connected to the comparator 303. Elements other than the determination value memory 308A or the selection circuit 307A (such as a resistive element, a capacitive element, and a logic circuit) may be disposed on the electrical path between the gain switch circuit 302 and the output node of the comparator 303. Elements other than the determination value memory 308B or the selection circuit 307B (such as a resistive element, a capacitive element, and a logic circuit) may be disposed on the electrical path between the ramp signal switch circuit 304 and the output node of the comparator 303.

The determination value memory 308A stores the result of comparison made between the first voltage value VREF1 and the column amplifier output signal AMPOUT by the comparator 303 (first J signal). The first J signal is also input to the selection circuit 307A. The selection circuit 307A outputs the first J signal to the gain switch circuit 302. The determination value memory 308B stores the result of comparison made between the second voltage value VREF2 and the column amplifier output signal AMPOUT by the comparator 303 (second J signal). The second J signal is also input to the selection circuit 307B. The selection circuit 307B outputs the second J signal to the ramp signal switch circuit 304.

In this modification, AD conversion can be performed by switching the gain of the column amplifier 301 based on the signal output level of the pixel signal PIXOUT output from the pixel 101 and then switching the gradient of the ramp signal VRAMP based on the signal output level of the column amplifier output signal AMPOUT output from the column amplifier 301. The operation of the column amplifier gain and the AD conversion gain can be optimized by such an operation.

In the photoelectric conversion apparatus, the column circuits 104 can be arranged in an array corresponding to the layout pitch of the pixels 101. In such a case, the column circuits 104 are laid out to extend in one direction. According to this modification, the selection circuits 307A and 307B and the determination value memories 308A and 308B are separately arranged as illustrated in FIG. 9. This allows flexible determination of the layout positions of the components based on the layout positions of the column amplifiers 301 and the comparators 303.

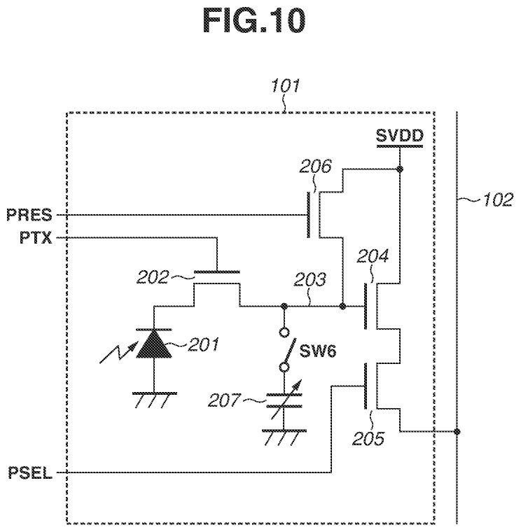

A photoelectric conversion apparatus according to a second exemplary embodiment of the disclosure will be described with reference to FIG. 10. Similar components to those of the first exemplary embodiment are denoted by the same reference numerals. A description of such components may be omitted or simplified.

The present exemplary embodiment differs from the first exemplary embodiment in that the gains of the pixel signals PIXOUT can be switched inside the pixels 101. FIG. 10 is an example of a circuit diagram of a pixel 101 included in the photoelectric conversion apparatus according to the present exemplary embodiment.

As illustrated in FIG. 10, a variable capacitor 207 is connected to the FD 203 via a switch SW6. The amount of a charge accumulated in the photoelectric conversion unit 201 is converted into a voltage by the capacitance of the FD 203. With the switch SW6 turned on to connect the variable capacitor 207, a pixel signal PIXOUT based on Eq. (1) can be output to the vertical output line 102:

$$Pixel signal PIXOUT = Q / ( Cfd 0 + Cfd ) , \qquad ( 1 )$$

where Q is the charge accumulated in the photoelectric conversion unit 201, Cfd0 is the capacitance of the FD 203, and Cfd is the capacitance of the variable capacitor 207.

The pixel signal PIXOUT can be controlled by controlling the capacitance Cfd of the variable capacitor 207. In other words, the variable capacitor 207 and the switch SW6 included in the pixel 101 function as a gain setting circuit. Further, a configuration including an element or elements other than the variable capacitor 207 or the switch SW6 may function as the gain setting circuit. The switching of the capacitance Cfd and the control of the switch SW6 may be implemented by the selection circuit 306 or the gain switch circuit 302. A not-illustrated other selection circuit or a control circuit for controlling the switch SW6 may be provided. A control signal line for controlling the switch SW6 is laid in parallel with the vertical output line 102, for example. In such a case, the switching of the capacitances in all rows may be simultaneously controlled in reading a row. Each pixel 101 may include an additional switch to be controlled by the control signal PSEL for controlling the selection MOS transistor 205, whereby the switching is controlled row by row.

In the present exemplary embodiment, AD conversion can be performed by switching the gain of the column amplifier 301 based on the signal output level of the pixel signal PIXOUT output from the pixel 101 and then switching the gradient of the ramp signal VRAMP based on the signal output level of the column amplifier output signal AMPOUT output from the column amplifier 301. The operation of the column amplifier gain and the AD conversion gain can be optimized by such an operation.

The first exemplary embodiment is configured to control the column amplifier output signal AMPOUT input to the comparator 303 by the selection circuit 306 controlling the gain switch circuit 302 and thereby switching the gain of the column amplifier 301. In contrast, the present exemplary embodiment is configured to control the column amplifier output signal AMPOUT input to the comparator 303 by controlling the amplitude of the pixel signal PIXOUT input to the column amplifier 301.

With the configuration of the first exemplary embodiment, if the gain of the column amplifier 301 is high, the response time of the column amplifier output signal AMPOUT for gain switching can be long. In contrast, the present exemplary embodiment uses the switch SW6 and the variable capacitor 207 in the pixel 101 along with the column amplifier 301 outside the pixel 101. This can reduce the response time compared to the case where only the column amplifier 301 is used for high gain driving.

Since the amplitude of the input signal to the comparator 303 can be controlled even without the column amplifier 301, the column amplifier 301 may or may not be provided as in the first exemplary embodiment. Without the column amplifier 301, the noise, area, and power consumption due to the elements constituting the column amplifier 301 can be reduced.

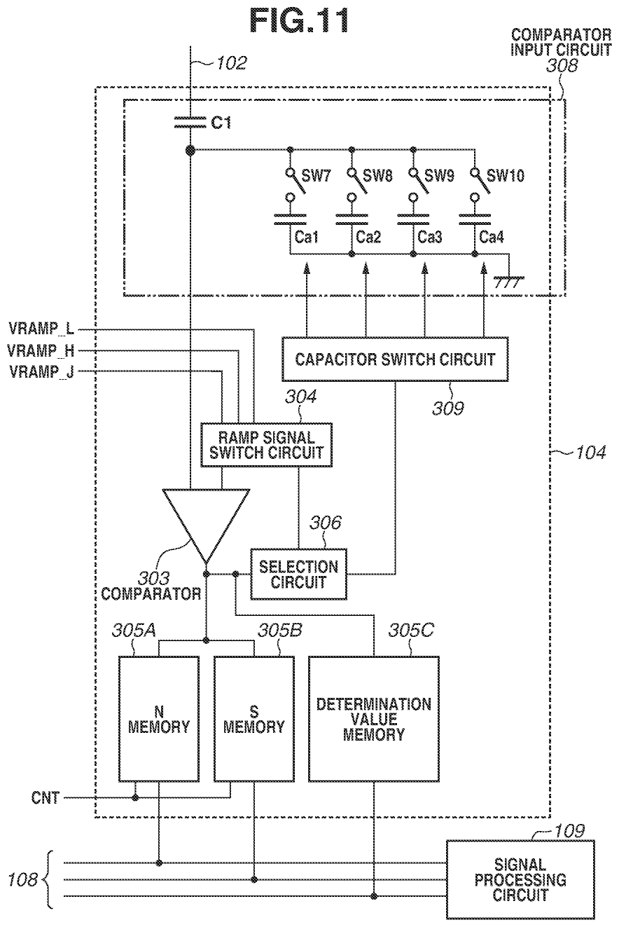

A photoelectric conversion apparatus according to a third exemplary embodiment of the disclosure will be described with reference to FIG. 11. Similar components to those of the first and second exemplary embodiments are denoted by the same reference numerals. A description of such components may be omitted or simplified.

The present exemplary embodiment differs from the first and second exemplary embodiments in that the gain of the pixel signal PIXOUT can be switched using an attenuation circuit instead of the column amplifier 301. FIG. 11 is an example of a block diagram of a column circuit 104 included in the photoelectric conversion apparatus according to the present exemplary embodiment.

As illustrated in FIG. 11, the column circuit 104 includes a comparator input circuit 308 and a capacitor switch circuit 309. The comparator input circuit 308 includes a capacitor C1, switches SW7 to SW10, and capacitors Ca1 to Ca4. The switches SW7 to SW10 are controlled by the capacitor switch circuit 309. One of the nodes of the capacitor C1 is connected to the vertical output line 102, and the other node is connected to one of the nodes of each of the capacitors Ca1 to Ca4 via the switches SW7 to SW10, respectively. A fixed voltage is supplied to the other nodes of the capacitors Ca1 to Ca4. The comparator input circuit 308 is a gain setting circuit functioning as an attenuation circuit. The comparator input circuit 308 controls the pixel signal PIXOUT based on the result of the gain setting by the capacitor switch circuit 309, and outputs the resulting pixel signal PIXOUT to the comparator 303. In other words, the comparator input circuit 308 can process the pixel signal PIXOUT output from the pixel 101 with a plurality of gains. The gain is determined by the ratio of the capacitance of the capacitor C1 and a capacitor or capacitors Ca1 to Ca4 selected by the switches SW7 to SW10. Like the operation for controlling the column amplifier 301 by the gain switch circuit 302 described in the first exemplary embodiment, the capacitor switch circuit 309 controls the comparator input circuit 308 based on a signal output from the selection circuit 306.

In the present exemplary embodiment, AD conversion can be performed by switching the gain of the comparator input circuit 308 based on the signal pixel level of the pixel signal PIXOUT output from the pixel 101 and then switching the gradient of the ramp signal VRAMP based on the signal output level of the pixel signal PIXOUT output from the comparator input circuit 308. The operation of the gain of the comparator input circuit 308 and the AD conversion gain can be optimized by such an operation.

Moreover, in the present exemplary embodiment, the provision of the comparator input circuit 308 instead of the column amplifier 301 can reduce the response time in situations where the column amplifier 301 takes long to respond. Without the column amplifier 301, the noise, area, and power consumption due to the elements constituting the column amplifier 301 can be reduced.

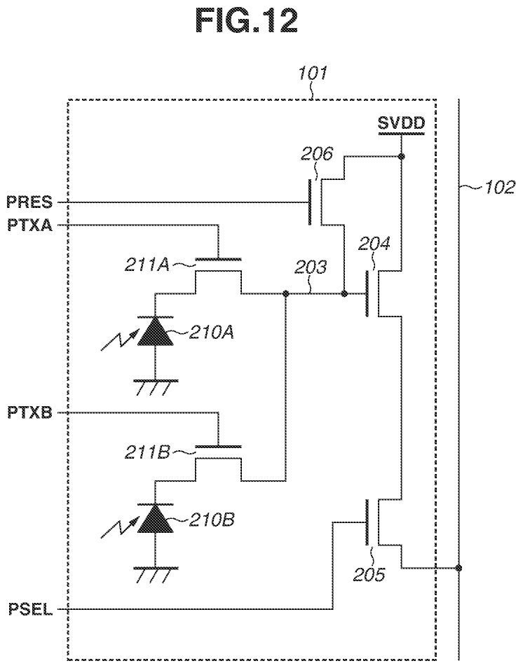

A photoelectric conversion apparatus according to a fourth exemplary embodiment of the disclosure will be described with reference to FIGS. 12 to 14. Similar components to those of the first, second, and third exemplary embodiments are denoted by the same reference numerals. A description of such components may be omitted or simplified.

The present exemplary embodiment differs from the first, second, and third exemplary embodiments in that each pixel 101 includes two photoelectric conversion units 210 and a microlens and is configured to be capable of detecting a phase difference. FIG. 12 is an example of a circuit diagram of a pixel 101 included in the photoelectric conversion apparatus according to the present exemplary embodiment.

The pixel 101 according to the exemplary embodiment includes two photoelectric conversion units (first and second photoelectric conversion units) 210A and 210B, two transfer MOS transistors 211A and 211B, and a not-illustrated microlens. Light passed through the microlens is detected by the first photoelectric conversion unit 210A and the second photoelectric conversion unit 210B. Such a structure allows phase-difference focus detection using a signal obtained from the first photoelectric conversion unit 210A and a signal obtained from the second photoelectric conversion unit 210B. Signal data for forming a captured image can be obtained by adding the signal obtained from the first photoelectric conversion unit 210A and the signal obtained from the second photoelectric conversion unit 210B. Either one of the signals obtained from the first and second photoelectric conversion units 210A and 210B may be used by itself without addition. Signal data for forming a captured image may be obtained by separately using the respective signals.

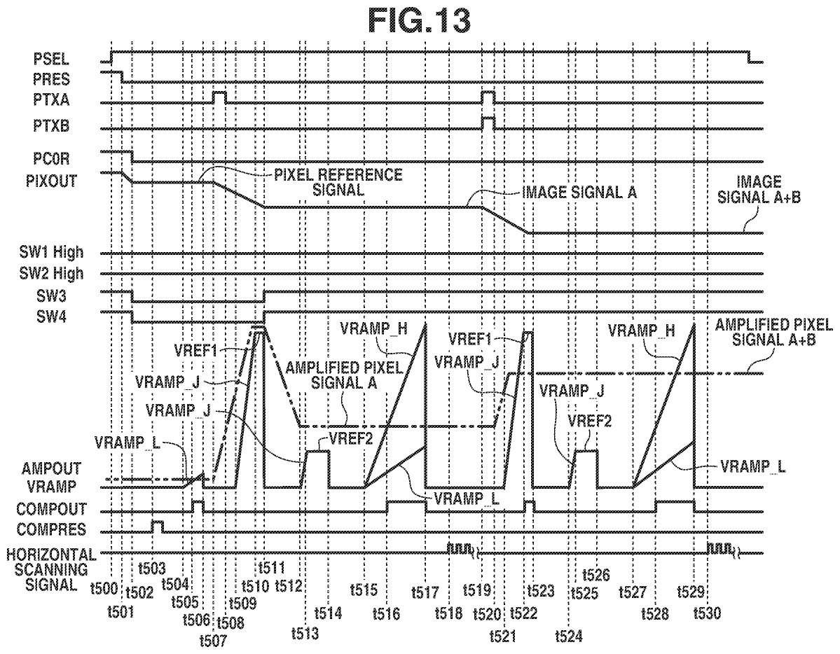

FIG. 13 is an example of a driving timing chart of a charge read operation by the photoelectric conversion apparatus according to the present exemplary embodiment. FIG. 13 schematically illustrates the timings of driving pulses, and a pixel output voltage, a column amplifier output voltage, and ramp signals. The gain-setting periods from time t507 to time t511 and from time t519 to time t523 will be referred to as first steps. The periods from time t512 to time t514 and from time t524 to time t526 where the gradient of the ramp signal VRAMP is set will be referred to as second steps. The periods from time t515 to time t517 and from time t527 to time t529 where AD conversion is performed will be referred to as third steps. The period from time t504 to time t506 where AD conversion is performed will be referred to as a fourth step. An operation for resetting (initializing) the comparator 303 is performed at a plurality of timings. A first step and a second step are performed using the pixel signal output from the first photoelectric conversion unit 201A, between two consecutive ones of the plurality of timings. At least either a third step or the fourth step may be performed using the pixel signal output from the first photoelectric conversion unit 210A in addition to the first and second steps, between the two consecutive ones of the plurality of timings. Moreover, a second step is performed using the pixel signals output from the first and second photoelectric conversion units 210A and 210B, between the two consecutive ones of the plurality of timings. At least either a first or a third step may be performed using the pixel signals output from the first and second photoelectric conversion units 210A and 210B in addition to the second step, between the two consecutive ones of the plurality of timings. That the operation for resetting (initializing) the comparator 303 is performed at a plurality of timings covers a case where the operation is performed once in each of a plurality of frames, for example. That the operation for resetting (initializing) the comparator 303 is performed at a plurality of timings also covers a case where the operation is performed a plurality of times in a frame, for example.

At time t500, the vertical scanning circuit 110 sets the selection pulse PSEL to a high level to select the row of pixels 101 to output pixel signals PIXOUT. The vertical scanning circuit 110 also sets the reset pulse PRES to a high level to reset the voltage of the FDs 203. At time t501, the vertical scanning circuit 110 sets the reset pulse PRES to a low level. A pixel signal PIXOUT output when the reset pulse PRES is set to the low level will be referred to as a “pixel reference signal”. The pixel reference signal is a signal containing a noise component of the pixel 101.

At time t502, the timing generation unit 111 changes the C0 reset pulse PCOR from a high level to a low level to end resetting the amplifier AMP and the input capacitor C0. A charge based on the voltage of the pixel reference signal when the C0 reset pulse PCOR is changed to the low level is thereby stored into the input capacitor C0. The column amplifier 301 outputs the column amplifier output signal AMPOUT. At time t503, the timing generation unit 111 sets the comparator reset pulse COMPRES to a high level, and after a predetermined time, to a low level. The comparator reset pulse COMPRES is intended to reset the comparator 303 for initialization.

The gain of the column amplifier 301 is determined by the ratio between the capacitance of the feedback capacitor(s) Cf1, Cf2, Cf3, and/or Cf4 connected to the feedback path of the amplifier AMP and the capacitance of the input capacitor C0. In the present exemplary embodiment, the feedback capacitors Cf1, Cf2, Cf3, and Cf4 have a capacitance ⅛ times, ⅛ times, ¼ times, and ½ times that of the input capacitor C0, respectively. If all the feedback capacitors Cf1, Cf2, Cf3, and Cf4 are used, the gain is 1/(⅛+⅛+¼+½)=1. If only the feedback capacitors Cf1 and Cf2 are used, the gain is 1/(⅛+⅛)=4. The gain combinations are not limited to those of the present exemplary embodiment. The gains may be switched by switching the input capacitor C0 instead of switching the feedback capacitors Cf. Suppose here that the switches SW3 and SW4 are turned off to use only the feedback capacitors Cf1 and Cf2, and the column amplifier 301 outputs the column amplifier output signal AMPOUT with a gain of 4× (first gain).

In the period from time t504 to time t506, the ramp signal output circuit 105 increases the voltage of the ramp signal VRAMP_L from its initial value in a time-dependent manner. The ramp signal output circuit 105 can simultaneously output a plurality of ramp signals with different gradients and input the ramp signals to the column circuits 104. For example, the plurality of ramp signals with different gradients includes the ramp signal VRAMP_L with a low gradient, the ramp signal VRAMP_H with a high gradient, and the ramp signal VRAMP_J with an even higher gradient. Further, the gradient of the ramp signal VRAMP_J may be lower than that of the ramp signal VRAMP_H or lower than that of the ramp signal VRAMP_L. Suppose here that the ramp signal VRAMP_L is input to the comparator 303 via the ramp signal switch circuit 304. The use of the ramp signal VRAMP_L as the reference voltage allows high-resolution AD conversion since the amount of voltage change per time is smaller than when the ramp signal VRAMP_H is used. In the period from time t504 to time t506, high-resolution AD conversion is performed using the ramp signal VRAMP_L. Such driving is implemented by the timing generation unit 111 transmitting the control signals to the ramp signal output circuit 105 and the ramp signal switch circuit 304. Suppose that the gradient of the ramp signal VRAMP_L is a first gradient, that of the ramp signal VRAMP_H is a second gradient higher than the first gradient, and that of the ramp signal VRAMP_J is a third gradient higher than the second gradient. In the period from time t504 to time t506, the column amplifier output signal AMPOUT processed with the first gain is compared with the ramp signal VRAMP having the first or second gradient. The column amplifier output signal AMPOUT processed with the first gain, which is an analog signal, is then converted into a digital signal based on such a fourth result of comparison.

At time t504, the ramp signal output circuit 105 starts to change the voltage of the ramp signal VRAMP_L. The counter circuit 106 starts to count the clock pulse signal CLK and supplies the count signal CNT to the N memory 305A in each column. At time t505, the voltage of the ramp signal VRAMP_L exceeds the column amplifier output signal AMPOUT, and the signal value of the comparator output COMPOUT output by the comparator 303 changes. The value (count value) of the count signal CNT here is stored in the N memory 305A. The value of the count signal CNT stored in the N memory 305A here is a digital value obtained by AD-converting the N signal. At time t506, the ramp signal output circuit 105 stops changing the voltage of the ramp signal VRAMP_L in a time-dependent manner, and resets the ramp signal VRAMP_L to the state of time t500. The counter circuit 106 stops counting the clock pulse signal CLK, and resets the count signal CNT to the initial value.

At time t507, the vertical scanning circuit 110 sets a transfer pulse PTXA to a high level. At time t508, the vertical scanning circuit 110 sets the transfer pulse PTXA to a low level. The charge generated by the light incident on the first photoelectric conversion unit 210A is thereby transferred to the FD 203. The amplification MOS transistor 204 outputs the voltage signal based on the charge transferred to the FD 203. This voltage signal is output to the vertical output line 102 via the selection MOS transistor 205. The output signal is an image signal A that is a kind of pixel signal PIXOUT. The image signal A is an analog signal having a voltage corresponding to the amount of light received by the first photoelectric conversion unit 210A in one frame period.

The column amplifier 301 outputs a column amplifier output signal AMPOUT obtained by inverting and amplifying a voltage difference between the pixel reference signal and the image signal A. The column amplifier output signal AMPOUT here will be referred to as an “amplified image signal A”. The amplified image signal A is input to one of the input terminals of the comparator 303. The column amplifier 301 may output a column amplifier output signal AMPOUT obtained by inverting and amplifying the image signal A. The amplified image signal A, as well as the column amplifier output signal AMPOUT obtained by inverting and amplifying the image signal A, is handled as an S signal in the signal processing at the stages subsequent to the column amplifier 301.

In the period from time t509 to time t511, the ramp signal VRAMP_J is input to the other input terminal of the comparator 303. The ramp signal VRAMP_J is output by the ramp signal output circuit 105 and input to the comparator 303 via the ramp signal switch circuit 304.

In the period from time t509 to time t510, the ramp signal output circuit 105 increases the voltage of the ramp signal VRAMP_J from its initial value in a time-dependent manner. At time t510, the ramp signal output circuit 105 stops changing the voltage of the ramp signal VRAMP_J. The voltage of the ramp signal VRAMP_J at time t510 is the first voltage value VREF1. The first voltage value VREF1 is used as a threshold for determining whether the column amplifier output signal AMPOUT exceeds the input range of AD conversion.

In the period from time t510 to time t511, the comparator 303 compares the first voltage value VREF1 and the column amplifier output signal AMPOUT processed with the first gain. If the voltage of the column amplifier output signal AMPOUT is lower than the first voltage value VREF1, the comparator output COMPOUT (first J signal) changes from the low level to a high level (=1). The comparator output COMPOUT based on such a first result of comparison between the first voltage value VREF1 and the column amplifier output signal AMPOUT processed with the first gain is input to the selection circuit 306. The selection circuit 306 outputs a switch signal to the gain switch circuit 302. The gain switch circuit 302 inputs a gain switch signal to the column amplifier 301. If the voltage of the column amplifier output signal AMPOUT processed with the first gain is lower than the first voltage value VREF1, the switches SW1 to SW4 remain unchanged and the gain is maintained at 4× (first gain). In other words, in the first step, the gain is set to the first gain (4×) based on the first result.

If the voltage of the column amplifier output signal AMPOUT is higher than the first voltage value VREF1, the comparator output COMPOUT (first J signal) changes to the low level (=0). The comparator output COMPOUT based on the first result of comparison between the first voltage value VREF1 and the column amplifier output signal AMPOUT processed with the first gain is input to the selection circuit 306. The selection circuit 306 outputs a switch signal to the gain switch circuit 302. The gain switch circuit 302 inputs a gain switch signal to the column amplifier 301. If the voltage of the column amplifier output signal AMPOUT processed with the first gain is higher than the first voltage value VREF1, the switches SW3 and SW4 are turned on to set the gain to 1× (second gain different from the first gain). In other words, in the first step, the setting of the first gain (4×) is switched to the second gain (1×) based on the first result.

In the period from time t510 to time t511, the value of the comparator output COMPOUT (first determination value J1) is input to the selection circuit 306. The first determination value J1 is also stored into the determination value memory 305C. FIG. 13 illustrates an example where the column amplifier output signal AMPOUT is higher than VREF1 and the gain is switched from 4× to 1×. At time t511, the determination as to which gain of the column amplifier 301 to use in the S signal AD conversion period, 1× or 4×, ends. The ramp signal output circuit 105 resets the voltage of the ramp signal VRAMP_J.

In the period from time t512 to time t513, the ramp signal output circuit 105 increases the voltage of the ramp signal VRAMP_J from its initial value in a time-dependent manner. At time t513, the ramp signal output circuit 105 stops changing the voltage of the ramp signal VRAMP_J. The voltage of the ramp signal VRAMP_J at time t513 is the second voltage value VREF2. This second voltage value VREF2 is used as a threshold for determining which to select as the ramp signal for AD-converting the column amplifier output signal AMPOUT, the ramp signal VRAMP_L or the ramp signal VRAMP_H.

In the period from time t513 to time t514, the comparator 303 compares the second voltage value VREF2 and the column amplifier output signal AMPOUT processed with the first or second gain set in the first step. In the present exemplary embodiment illustrated in FIG. 13, the column amplifier output signal AMPOUT is processed with the second gain based on the first result of the first step. If the voltage of the column amplifier output signal AMPOUT is lower than the second voltage value VREF2, the comparative output COMPOUT (second J signal) changes from the low level to the high level (=1). The comparator output COMPOUT based on the second result of comparison between the second voltage value VREF2 and the column amplifier output signal AMPOUT processed with the second gain is input to the selection circuit 306. The selection circuit 306 outputs a switch signal to the ramp signal switch circuit 304. The ramp signal switch circuit 304 selects the ramp signal VRAMP_L and inputs the ramp signal VRAMP_L to the comparator 303.

If the voltage of the column amplifier output signal AMPOUT processed with the second gain is lower than the second voltage value VREF2, the ramp signal VRAMP_L with the low gradient is used for AD conversion. In other words, in the second step, the first gradient (high AD conversion gain) lower than the second gradient (low AD conversion gain) is set based on the second result.

If the voltage of the column amplifier output signal AMPOUT is higher than the second voltage value VREF2, the comparator output COMPOUT (second J signal) is at the low level (=0). The comparator output COMPOUT based on the second result of comparison between the second voltage value VREF2 and the column amplifier output signal AMPOUT processed with the second gain is input to the selection circuit 306. The selection circuit 306 outputs a switch signal to the ramp signal switch circuit 304. The ramp signal switch circuit 304 selects the ramp signal VRAMP_H and inputs the ramp signal VRAMP_H to the comparator 303. If the voltage of the column amplifier output signal AMPOUT processed with the second gain is higher than the second voltage value VREF2, the ramp signal VRAMP_H with the gradient higher than that of the ramp signal VRAMP_L is used for AD conversion. In other words, in the second step, the second gradient (low AD conversion gain) higher than the first gradient (high AD conversion gain) is set based on the second result.

By the foregoing driving method, AD conversion can be performed with appropriate resolution based on the signal output level of the column amplifier output signal AMPOUT processed with the second gain, without exceeding the AD conversion input range. In other words, both the resolution and the frame rate can be improved in a compatible manner.

In the period from time t513 to time t514, the value of the comparator output COMPOUT (second determination value J2) is input to the selection circuit 306. The second determination value J2 is also stored into the determination value memory 305C. At time t514, the determination as to which signal to use in the S signal AD conversion period, the ramp signal VRAMP_H or VRAMP_L, ends. The ramp signal output circuit 105 resets the voltage of the ramp signal VRAMP_J.

In the period from time t515 to time t517, the ramp signal output circuit 105 increases the voltage of the ramp signal VRAMP_L or VRAMP_H from its initial value in a time-dependent manner. The column amplifier output signal AMPOUT processed with the first or second gain is then compared with the ramp signal VRAMP having the first or second gradient. The column amplifier output signal AMPOUT processed with the first or second gain, which is an analog signal, is converted into a digital signal based on such a third result of comparison. Which ramp signal for each column circuit 104 to input to its comparator 303, VRAMP_L or VRAMP_H, is determined based on the value of the comparator output COMPOUT between time t513 and time t514. In the case of FIG. 13, the column amplifier output signal AMPOUT in the period from time t513 to time t514 is higher than the second voltage value VREF2, and the ramp signal VRAMP_H with the higher gradient, or second gradient, is thus selected.

At time t515, the ramp signal output circuit 105 starts to change the voltage of the ramp signal VRAMP_H. The counter circuit 106 starts to count the clock pulse signal CLK and supplies the count signal CNT to the S memory 305B in each column.

At time t516, the voltage of the ramp signal VRAMP_H exceeds the column amplifier output signal AMPOUT, and the signal value of the comparator output COMPOUT changes. The value (count value) of the count signal CNT here is stored in the S memory 305B. The value of the count signal CNT stored in the S memory 305B here is a digital value obtained by AD-converting the S signal.

At time t517, the ramp signal output circuit 105 stops changing the voltage of the ramp signal VRAMP_L or VRAMP_H in a time-dependent manner, and resets the ramp signal VRAMP_L or VRAMP_H to the state of time t500. The counter circuit 106 stops counting the clock pulse signal CLK and restores the count signal CNT to its initial value.

Each memory includes a write memory to which the output terminal of the comparator 303 is connected and a read memory to which an input terminal of the signal processing circuit 109 is connected. The digital signals written to the write memories are transferred to and stored in the read memories.

At and after time t518, the horizontal scanning circuit 107 sequentially operates the column circuits 104, whereby the signals stored in the N memory 305A, the S memory 305B, and the determination value memory 305C in each column circuit 104 are transmitted to the signal processing circuit 109 via the horizontal output lines 108. After calculation processing, the signals are output to outside the photoelectric conversion apparatus. In the meantime, the write memories are ready for next AD conversion results to be written. Each memory can thus be written and read in parallel.

The signal processing circuit 109 calculates a differential signal level (light component) by subtracting the digitized N signal from the digitized S signal. Before the calculation of the S signal minus the N signal, the AD conversion result of the S signal is corrected using the ramp signal selected in AD-converting the S signal. The signal processed here will be referred to as a digital signal A. The processing for correcting the AD conversion result will now be described. For example, if the gradient of the ramp signal VRAMP_H is four times that of the ramp signal VRAMP_L, the signal amplitude of the ramp signal VRAMP_H for one count of the count signal CNT is four times. To match the digital outputs corresponding to the same signal voltage level, the count value AD-converted with the ramp signal VRAMP_H is therefore quadrupled using a digital gain. Whether to correct the S signal input to the signal processing circuit 109 can be determined based on the second determination value J2 stored in the determination value memory 305C. If the second determination value J2=0, the processing for quadrupling the S signal is performed since the ramp signal VRAMP_H is selected. On the other hand, if the second determination value J2=1, the processing for quadrupling the S signal is not performed since the ramp signal VRAMP_L is selected. Such processing will be referred to as first correction processing.

Next, at time t519, the vertical scanning circuit 110 sets the transfer pulse PTXA and a transfer pulse PTXB to a high level. At time t520, the vertical scanning circuit 110 sets the transfer pulses PTXA and PTXB to a low level. The charges generated by the light incident on the first and second photoelectric conversion units 210A and 210B are thereby both transferred to the FD 203 and added. The amplification MOS transistor 204 outputs a voltage signal based on the charges transferred to the FD 203. This voltage signal is output to the vertical output line 102 via the selection MOS transistor 205. This signal is an image signal A+B that is a kind of pixel signal PIXOUT. The image signal A+B is an analog signal having a voltage corresponding to the amount of light received by the first and second photoelectric conversion units 210A and 210B in one frame period.

The column amplifier 301 outputs a column amplifier output signal AMPOUT obtained by inverting and amplifying a voltage difference between the pixel reference signal and the image signal A+B. The column amplifier output signal AMPOUT here will be referred to as an “amplified image signal A+B”. The amplified image signal A+B is input to one of the input terminals of the comparator 303. The column amplifier 301 may output a column amplifier output signal AMPOUT obtained by inverting and amplifying the image signal A+B. The amplified image signal A+B, as well as the column amplifier output signal AMPOUT obtained by inverting and amplifying the image signal A+B, is handled as an S signal in the signal processing at the stages subsequent to the column amplifier 301.

In the period from time t521 to time t523, the ramp signal VRAMP_J is input to the other input terminal of the comparator 303. The ramp signal VRAMP_J is output by the ramp signal output circuit 105 and input to the comparator 303 via the ramp signal switch circuit 304.

In the period from time t521 to time t522, the ramp signal output circuit 105 increases the voltage of the ramp signal VRAMP_J from its initial value in a time-dependent manner. At time t522, the ramp signal output circuit 105 stops changing the voltage of the ramp signal VRAMP_J. The voltage of the ramp signal VRAMP_J at time t522 is the first voltage value VREF1. The first voltage value VREF1 is used as a threshold for determining whether the column amplifier output signal AMPOUT exceeds the input range of AD conversion.

In the period from time t522 to time t523, the comparator 303 compares the first voltage value VREF1 and the column amplifier output signal AMPOUT processed with the first gain. If the voltage of the column amplifier output signal AMPOUT is lower than the first voltage value VREF1, the comparator output COMPOUT (first J signal) changes from the low level to the high level (=1). The comparator output COMPOUT based on the first result of comparison between the first voltage value VREF1 and the column amplifier output signal AMPOUT processed with the first gain is input to the selection circuit 306. The selection circuit 306 outputs a switch signal to the gain switch circuit 302. The gain switch circuit 302 inputs a gain switch signal to the column amplifier 301. If the voltage of the column amplifier output signal AMPOUT processed with the first gain is lower than the first voltage value VREF1, the switches SW1 to SW4 remain unchanged and the gain is maintained at 4× (first gain). In other words, in the first step, the gain is set to the first gain (4×) based on the first result.

If the voltage of the column amplifier output signal AMPOUT is higher than the first voltage value VREF1, the comparator output COMPOUT (first J signal) is at the low level (=0). The comparator output COMPOUT based on the first result of comparison between the first voltage value VREF1 and the column amplifier output signal AMPOUT processed with the first gain is input to the selection circuit 306. The selection circuit 306 outputs a switch signal to the gain switch circuit 302. The gain switch circuit 302 inputs a gain switch signal to the column amplifier 301. If the voltage of the column amplifier output signal AMPOUT processed with the first gain is higher than the first voltage value VREF1, the switches SW3 and SW4 are turned on to set the gain to 1× (second gain different from the first gain). In other words, in the first step, the setting of the first gain (4×) is switched to the second gain (1×) based on the first result.

In the period from time t522 to time t523, the value of the comparator output COMPOUT (first determination value J1) is input to the selection circuit 306. The first determination value J1 is also stored into the determination value memory 305C. In the case of FIG. 13, in the first step using the amplified image signal A in the period from time t507 to time t511, the gain is switched from 4× to 1×, whereby the gain is set to 1×. Here, the amplified image signal A+B has a signal level higher than that of the amplified image signal A, and the gain is therefore not switched and remains at 1×. Despite the comparator output COMPOUT of high level, the correction processing of the signal processing circuit 109 does not malfunction since the determination value memory 305C is configured to hold the first result of the first step with the amplified image signal A. At time t523, the determination as to which gain of the column amplifier 301 to use in the S signal AD conversion period, 1× or 4×, ends. The ramp signal output circuit 105 resets the voltage of the ramp signal VRAMP_J.

In the period from time t524 to time t525, the ramp signal output circuit 105 increases the voltage of the ramp signal VRAMP_J from its initial value in a time-dependent manner. At time t525, the ramp signal output circuit 105 stops changing the voltage of the ramp signal VRAMP_J. The voltage of the ramp signal VRAMP_J at time t525 is the second voltage value VREF2. This second voltage value VREF2 is used as a threshold for determining which to select as the ramp signal for AD-converting the column amplifier output signal AMPOUT, the ramp signal VRAMP_L or the ramp signal VRAMP_H.

In the period from time t525 to time t526, the comparator 303 compares the second voltage value VREF2 and the column amplifier output signal AMPOUT processed with the first or second gain set in the first step. In the present exemplary embodiment illustrated in FIG. 13, the column amplifier output signal AMPOUT is processed with the second gain based on the first result of the first step. If the voltage of the column amplifier output signal AMPOUT is lower than the second voltage value VREF2, the comparative output COMPOUT (second J signal) changes from the low level to the high level (=1). The comparator output COMPOUT based on the second result of comparison between the second voltage value VREF2 and the column amplifier output signal AMPOUT processed with the second gain is input to the selection circuit 306. The selection circuit 306 outputs a switch signal to the ramp signal switch circuit 304. The ramp signal switch circuit 304 selects the ramp signal VRAMP_L and inputs the ramp signal VRAMP_L to the comparator 303.

If the voltage of the column amplifier output signal AMPOUT processed with the second gain is lower than the second voltage value VREF2, the ramp signal VRAMP_L with the low gradient is used for AD conversion. In other words, in the second step, the first gradient (high AD conversion gain) lower than the second gradient (low AD conversion gain) is set based on the second result.

If the voltage of the column amplifier output signal AMPOUT is higher than the second voltage value VREF2, the comparator output COMPOUT (second J signal) is at the low level (=0). The comparator output COMPOUT based on the second result of comparison between the second voltage value VREF2 and the column amplifier output signal AMPOUT processed with the second gain is input to the selection circuit 306. The selection circuit 306 outputs a switch signal to the ramp signal switch circuit 304. The ramp signal switch circuit 304 selects the ramp signal VRAMP_H and inputs the ramp signal VRAMP_H to the comparator 303. If the voltage of the column amplifier output signal AMPOUT processed with the second gain is higher than the second voltage value VREF2, the ramp signal VRAMP_H with the gradient higher than that of the ramp signal VRAMP_L is used for AD conversion. In other words, in the second step, the second gradient (low AD conversion gain) higher than the first gradient (high AD conversion gain) is set based on the second result.

By the foregoing driving method, AD conversion can be performed with appropriate resolution based on the signal output level of the column amplifier output signal AMPOUT processed with the second gain, without exceeding the AD conversion input range. In other words, both the resolution and the frame rate can be improved in a compatible manner.

In the period from time t525 to time t526, the value of the comparator output COMPOUT (second determination value J2) is input to the selection circuit 306. The second determination value J2 is also stored into the determination value memory 305C. At time t526, the determination as to which signal to use in the S signal AD conversion period, the ramp signal VRAMP_H or VRAMP_L, ends. The ramp signal output circuit 105 resets the voltage of the ramp signal VRAMP_J.

In the period from time t527 to time t529, the ramp signal output circuit 105 increases the voltage of the ramp signal VRAMP_L or VRAMP_H from its initial value in a time-dependent manner. The column amplifier output signal AMPOUT processed with the first or second gain is then compared with the ramp signal VRAMP having the first or second gradient. The column amplifier output signal AMPOUT processed with the first or second gain, which is an analog signal, is converted into a digital signal based on such a third result of comparison. Which ramp signal for each column circuit 104 to input to its comparator 303, VRAMP_L or VRAMP_H, is determined based on the value of the comparator output COMPOUT between time t525 and time t526. In the case of FIG. 13, the column amplifier output signal AMPOUT in the period from time t525 to time t526 is higher than the second voltage value VREF2, and the ramp signal VRAMP_H with the higher gradient, or second gradient, is thus selected.

At time t527, the ramp signal output circuit 105 starts to change the voltage of the ramp signal VRAMP_H. The counter circuit 106 starts to count the clock pulse signal CLK and supplies the count signal CNT to the S memory 305B in each column.

At time t528, the voltage of the ramp signal VRAMP_H exceeds the column amplifier output signal AMPOUT, and the signal value of the comparator output COMPOUT changes. The value (count value) of the count signal CNT here is stored in the S memory 305B. The value of the count signal CNT stored in the S memory 305B here is a digital value obtained by AD-converting the S signal.

At time t529, the ramp signal output circuit 105 stops changing the voltage of the ramp signal VRAMP_L or VRAMP_H in a time-dependent manner, and resets the ramp signal VRAMP_L or VRAMP_H to the state of time t500. The counter circuit 106 stops counting the clock pulse signal CLK and restores the count signal CNT to its initial value.

At and after time t530, the horizontal scanning circuit 107 sequentially operates the column circuits 104, whereby the signals stored in the N memory 305A, the S memory 305B, and the determination value memory 305C in each column circuit 104 are transmitted to the signal processing circuit 109 via the horizontal output lines 108. After calculation processing, the signals are output to outside the photoelectric conversion apparatus.

More specifically, at and after time t530, the signals written to the write memories are transferred to and stored in the read memories. The horizontal scanning circuit 107 sequentially operates the column circuits 104, whereby the signals stored in the read memories of the N memory 305A, the S memory 305B, and the determination value memory 305C in each column circuit 104 are transmitted to the signal processing circuit 109 via the horizontal output lines 108. After calculation processing, the signals are output to outside the photoelectric conversion apparatus.

The signal processing circuit 109 calculates a differential signal level (light component) by subtracting the digitized N signal from the digitized S signal. Before the calculation of the S signal minus the N signal, the AD conversion result of the S signal is corrected like the digital signal A, using the ramp signal selected in AD-converting the S signal. The signal processed here will be referred to as a digital signal A+B.

Of the digital signals A and A+B output to outside the photoelectric conversion apparatus, the digital signal A+B is used as an imaging signal. A phase difference can be detected based on an output difference between a digital signal B obtained by subtracting the digital signal A from the digital signal A+B and the digital signal A.

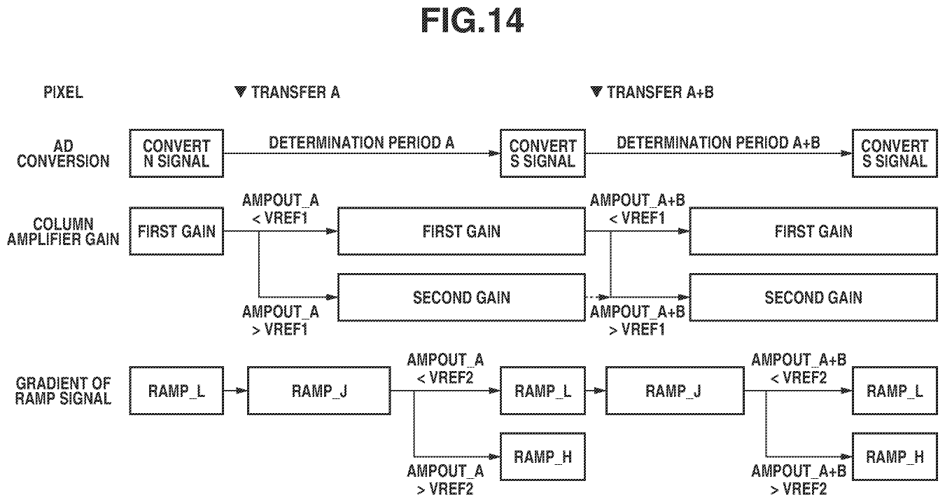

FIG. 14 is a diagram for describing a flowchart of signal processing by the photoelectric conversion apparatus according to the present exemplary embodiment.

“PIXEL” illustrated in FIG. 14 indicates the timing of the transfer operation by the first photoelectric conversion unit 210A with “▾ TRANSFER A”, and the timing of the transfer operation by the first and second photoelectric conversion units A and B with “▾ TRANSFER A+B”. The column amplifier output signal AMPOUT corresponding to transfer A is denoted by AMPOUT_A, and the column amplifier output signal AMPOUT corresponding to transfer A+B by AMPOUT_A+B. A determination period corresponding to transfer A will be referred to as a determination period A, and a determination period corresponding to transfer A+B as a determination period A+B. “AD CONVERSION” illustrated in FIG. 14 indicates the AD conversion period of the N signal, the determination periods (setting of the column amplifier gain and the gradient of the ramp signal), and the AD conversion period of the S signal. In the determination periods, the comparator 303 stores the determination values J (first and second determination values J1 and J2) based on the result of comparison between the column amplifier output signal AMPOUT and the ramp signal VRAMP_J into the determination value memory 305C. In the determination periods, the selection circuit 306 outputs signals to the gain switch circuit 302 and the ramp signal switch circuit 304 to control the switching of the gain of the column amplifier 301 and the ramp signal VRAMP. In “COLUMN AMPLIFIER GAIN” illustrated in FIG. 14, the first gain is 4× and the second gain is 1× as described with reference to FIG. 13, for example. After transfer A, the column amplifier output signal AMPOUT_A and the first voltage value VREF1 are compared in the determination period A. If AMPOUT_A<VREF1, the gain of the column amplifier 301 is maintained at the first gain setting. On the other hand, if AMPOUT_A>VREF1, the gain of the column amplifier 301 is set to the second gain different from the first gain. “GRADIENT OF RAMP SIGNAL” illustrated in FIG. 14 indicates the gradient of the ramp signal VRAMP input to the comparator 303. During the AD conversion of the N signal, the ramp signal VRAMP_L is input to the comparator 303, for example. During the determination periods, the selection circuit 306 outputs a signal so that the gain switch circuit 302 switches the gain of the column amplifier 301. The comparator 303 then compares the column amplifier output signal AMPOUT_A and the second voltage value VREF2. On the other hand, if the comparison result indicates that AMPOUT_A<VREF2, the ramp signal VRAMP_L is selected and the S signal is AD-converted. If the comparison result indicates that AMPOUT_A>VREF2, the ramp signal VRAMP_H is selected and the S signal is AD-converted. In other words, either the ramp signals VRAMP_L or VRAMP_H is selected for the first gain, and either one of the ramp signals VRAMP_L and VRAMP_H is selected for the second gain. In the present exemplary embodiment, there are therefore four combinations of the gain of the column amplifier 301 and the gradient of the ramp signal VRAMP. Further, the number of combinations of the gain of the column amplifier 301 and the gradient of the ramp signal VRAMP is not limited to four. The number of combinations depends on the number of gain settings of the column amplifier 301 and the number of gradient settings of the ramp signal VRAMP.

Next, after transfer A+B, the same operation as with transfer A is performed on the column amplifier output signal AMPOUT_A+B. For example, if the column amplifier output signal AMPOUT_A is higher than the first voltage value VREF1, the gain of the column amplifier 301 is set to the second gain. Further, the relationship AMPOUT_A<AMPOUT_A+B always holds after transfer A+B. If the second gain is set in the first step after transfer A, the gain of the column amplifier 301 will therefore not be switched from the second gain to the first gain in the first step after transfer A+B. The operation for comparing the column amplifier output signal AMPOUT_A+B and the first voltage value VREF1 during the determination period A+B can therefore be omitted to reduce the operation power.

The present exemplary embodiment provides the same effects as those of the first exemplary embodiment although the pixels are configured to be capable of phase difference detection. Specifically, the effect of noise occurring from the comparator 303 is relatively reduced, and a high dynamic range signal with an improved S/N ratio can be obtained. High-resolution AD conversion can be performed at high speed by setting the gain of the column amplifier 301 and then selecting an appropriate ramp signal VRAMP_H or VRAMP_L for AD conversion. For example, under low luminance, a signal having favorable noise characteristics can be obtained with high resolution by amplifying the pixel signal PIXOUT and performing AD conversion using the low-gradient ramp signal VRAMP_L. Under high luminance, a signal of extended dynamic range can be obtained at high speed by reducing the amplification ratio of the pixel signal PIXOUT and performing AD conversion using the high-gradient ramp signal VRAMP_H.

In the present exemplary embodiment, AD conversion can be performed by switching the gain of the column amplifier 301 based on the signal output level of the pixel signal PIXOUT output from the pixel 101 and then switching the gradient of the ramp signal VRAMP based on the signal output level of the column amplifier output signal AMPOUT output from the column amplifier 301. The operation of the column amplifier gain and the AD conversion gain can be optimized by such an operation.

The present exemplary embodiment is also applicable to a pixel configuration where the FD 203 is not shared by a plurality of photoelectric conversion units.

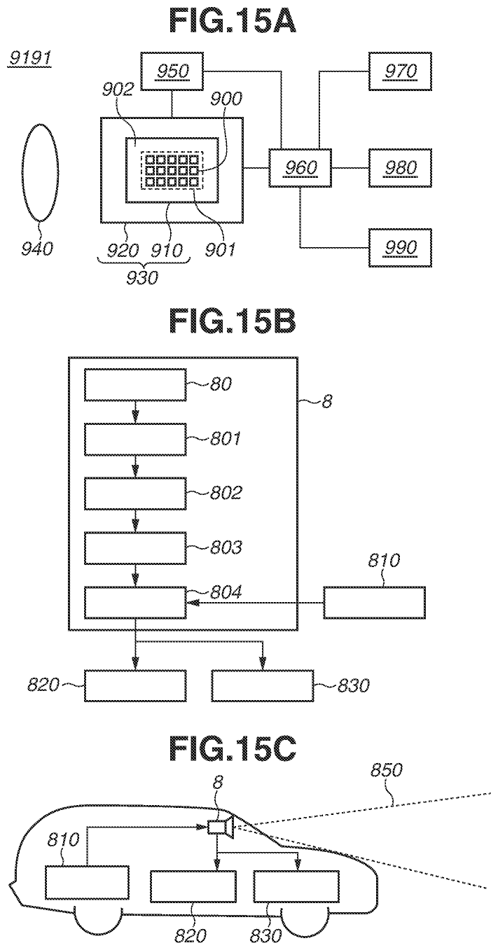

A fifth exemplary embodiment can be applied to any of the first to fourth exemplary embodiments. FIG. 15A is a schematic diagram for describing a device 9191 including a semiconductor apparatus 930 according to the present exemplary embodiment. The photoelectric conversion apparatuses according to any of the foregoing exemplary embodiments can be used as the semiconductor apparatus 930. The device 9191 including the semiconductor apparatus 930 will be described in detail. The semiconductor apparatus 930 can include a semiconductor device 910. Aside from the semiconductor device 910, the semiconductor apparatus 930 can include a package 920 that accommodates the semiconductor device 910. The package 920 can include a base to which the semiconductor device 910 is fixed, and a glass lid opposed to the semiconductor device 910. The package 920 can further include bonding members, such as bonding wires and bumps for connecting terminals on the base and terminals of the semiconductor device 910.

The device 9191 can include at least one of the following: an optical apparatus 940, a control apparatus 950, a processing apparatus 960, a display apparatus 970, a storage apparatus 980, and a mechanical apparatus 990. The optical apparatus 940 is compatible with the semiconductor apparatus 930. The optical apparatus 940 includes an optical system for guiding light to the semiconductor apparatus 930. Examples include a lens, a shutter, and a mirror. The control apparatus 950 controls the semiconductor apparatus 930. The control apparatus 950 is a semiconductor apparatus, such as an application-specific integrated circuit (ASIC).

The processing apparatus 960 processes a signal output from the semiconductor apparatus 930. The processing apparatus 960 is a semiconductor apparatus for constituting an analog front end (AFE) or a digital front end (DFE). Examples of the processing apparatus 960 include a central processing unit (CPU) and an ASIC. The display apparatus 970 is an electroluminescence (EL) display device or liquid crystal display device that displays information (image) obtained by the semiconductor apparatus 930. The storage apparatus 980 is a magnetic device or semiconductor device that stores the information (image) obtained by the semiconductor apparatus 930. The storage apparatus 980 is a volatile memory, such as a static random access memory (SRAM) and a dynamic random access memory (DRAM), or a nonvolatile memory, such as a flash memory and a hard disk drive.

The mechanical apparatus 990 includes a movable unit or a propulsion unit, such as a motor and an engine. The device 9191 displays the signal output from the semiconductor apparatus 930 on the display apparatus 970 or transmit the signal to outside using a communication apparatus (not illustrated) included in the device 9191. For that purpose, the device 9191 desirably further includes the storage apparatus 980 and the processing apparatus 960 aside from a storage circuit or calculation circuit of the semiconductor apparatus 930. The mechanical apparatus 990 may be controlled based on the signal output from the semiconductor apparatus 930.

The device 9191 is suitable for electronic devices, such as information terminals having an imaging function (for example, smartphones or wearable terminals) and cameras (for example, interchangeable lens cameras, compact cameras, video cameras, or surveillance cameras). In the case of a camera, the mechanical apparatus 990 can drive components of the optical apparatus 940 for zooming, focusing, and shutter operations. Alternatively, the mechanical apparatus 990 of the camera can move the semiconductor apparatus 930 for image stabilization operation.

The device 9191 can be a transportation device, such as a vehicle, a ship, and a flying object (drone or aircraft). The mechanical apparatus 990 on the transportation device can be used as a moving apparatus. The device 9191 serving as a transportation device is suitable to transport the semiconductor apparatus 930, or assist and/or automate driving (manipulation) using an imaging function. The processing apparatus 960 for assisting and/or automating driving (manipulation) can operate the mechanical apparatus 990 serving as a moving apparatus based on information obtained by the semiconductor apparatus 930. Alternatively, the device 9191 may be a medical device, such as an endoscope, a measurement device, such as a range sensor, an analytical instrument, such as an electron microscope, office equipment, such as a copying machine, and industrial equipment, such as a robot.

According to the foregoing exemplary embodiment, favorable pixel characteristics can be obtained. This can increase the value of the semiconductor apparatus 930. As employed herein, increasing the value applies to at least one of the following: adding functionality, improving performance, enhancing characteristics, increasing reliability, raising manufacturing yield, reducing environmental impact, reducing cost, reducing size, and reducing weight.

The use of the semiconductor apparatus 930 according to the present exemplary embodiment for the device 9191 can thus increase the value of the device 9191 as well. For example, mounting the semiconductor apparatus 930 on a transportation device can provide excellent performance in capturing images outside the transportation device or measuring the external environment. In manufacturing and selling the transportation device, the decision to mount the semiconductor apparatus 930 according to the present exemplary embodiment on the transportation device is therefore advantageous for improving the performance of the transportation device itself. In particular, the semiconductor apparatus 930 is suitable for a transportation device that uses information obtained by the semiconductor apparatus 930 for driving assistance and/or automatic driving.

A photoelectric conversion system and a moving body according to the present exemplary embodiment will be described with reference to FIGS. 15B and 15C.

FIG. 15B illustrates an example of a photoelectric conversion system related to an on-vehicle camera. A photoelectric conversion system 8 includes a photoelectric conversion apparatus 80. The photoelectric conversion apparatus 80 is the photoelectric conversion apparatus (imaging apparatus) according to one of the foregoing exemplary embodiments. The photoelectric conversion system 8 includes an image processing unit 801 that performs image processing on a plurality of pieces of image data obtained by the photoelectric conversion apparatus 80, and a parallax acquisition unit 802 that calculates a parallax (phase difference between parallax images) from the plurality of pieces of image data obtained by the photoelectric conversion system 8. The photoelectric conversion system 8 may include a not-illustrated optical system for guiding light to the photoelectric conversion apparatus 80, such as a lens, a shutter, and a mirror. Each pixel of the photoelectric conversion apparatus 80 may include a plurality of photoelectric conversion units substantially conjugate with the pupil of the optical system. For example, the plurality of photoelectric conversion units substantially conjugate with the pupil is arranged to correspond to a microlens. The plurality of photoelectric conversion units receives light beams that have passed through respective different positions of the pupil of the optical system, and the photoelectric conversion apparatus 80 thereby outputs image data corresponding to the light beams that have passed through the difference positions. The parallax acquisition unit 802 may calculate the parallax using the output image data. The photoelectric conversion system 8 also includes a distance acquisition unit 803 that calculates the distance to an object based on the calculated parallax, and a collision determination unit 804 that determines whether there is a possibility of collision based on the calculated distance. Here, the parallax acquisition unit 802 and the distance acquisition unit 803 are examples of a distance information acquisition unit that acquires distance information to an object. In other words, distance information is information about a parallax, a defocus amount, or the distance to an object. The collision determination unit 804 may determine the possibility of collision by using one of these pieces of distance information. The distance information may be acquired based on ToF. The distance information acquisition unit may be implemented by dedicatedly designed hardware or by software modules. A field programmable gate array (FPGA) or an ASIC may be used for implementation. A combination of these may be used for implementation.

The photoelectric conversion system 8 is connected to a vehicle information acquisition apparatus 810, and can acquire vehicle information, such as vehicle speed, yaw rate, and steering angle. The photoelectric conversion system 8 is also connected to a control engine control unit (ECU) 820. The control ECU 820 is a control apparatus that outputs a control signal for causing a braking force on the vehicle based on the determination of the collision determination unit 804. The photoelectric conversion system 8 is also connected to an alarm apparatus 830 that issues an alarm to the driver based on the determination of the collision determination unit 804. For example, if the collision determination unit 804 determines that there is a high possibility of collision, the control ECU 820 performs vehicle control for avoiding the collision or reducing damage by applying the brakes, easing off the accelerator, and/or reducing the engine output. The alarm apparatus 830 warns the user by issuing alarm sound, displaying alarm information on the screen of a car navigation system, and/or vibrating the seat belt or the steering wheel.

In the present exemplary embodiment, the photoelectric conversion system 8 captures images of the surroundings of the vehicle, for example, ahead of or behind the vehicle.

FIG. 15C illustrates the photoelectric conversion system 8 in the case of capturing images ahead of the vehicle (imaging range 850). The vehicle information acquisition apparatus 810 issues instructions to the photoelectric conversion system 8 or the photoelectric conversion apparatus 80. Such a configuration provides an improved ranging accuracy.

While the foregoing description has dealt with an example of controlling the vehicle to avoid collision with other vehicles, the present exemplary embodiment is also applicable to automatic driving control to follow other vehicles and automatic driving control to stay in the lane. Moreover, the photoelectric conversion system 8 is not limited to vehicles, such as an automobile, and can be applied to moving bodies (moving apparatuses), such as a ship, an aircraft, and an industrial robot. The photoelectric conversion apparatus 8 is not limited to moving bodies, either, and can be widely applied to devices using object recognition, such as intelligent transport systems (ITS).

As employed herein, the expressions “A or B”, “at least one of A and B”, “at least one of A and/or B”, and “one or more of A and/or B” can cover all possible combinations of the enumerated items unless otherwise explicitly defined. In other words, the foregoing expressions shall be understood to cover all cases where at least A is included, where at least B is included, and where at least A and at least B are both included. The same applies to combinations of three or more elements.

The foregoing exemplary embodiments can be modified as appropriate without departing from the technical concept. The disclosure of this specification is not limited to what is described herein, but includes all that can be understood from this specification and the drawings attached to this specification.

According to an exemplary embodiment of the disclosure, the operation of the column amplifier gain and the AD conversion gain can be optimized.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-067788, filed Apr. 18, 2023, which is hereby incorporated by reference herein in its entirety.

What is claimed is:

1. A method for driving a photoelectric conversion apparatus including at least one pixel configured to generate a pixel signal by photoelectric conversion, a gain setting circuit configured to process the pixel signal output from the at least one pixel with a plurality of gains, and a comparator configured to compare a signal output from the gain setting circuit and a ramp signal, the method comprising:
setting a gain of the plurality of gains to a first gain or a second gain different from the first gain based on a first result of comparison made between a signal voltage value of the signal processed with the first gain and a first voltage value by the comparator; and
then setting a gradient of the ramp signal based on a second result of comparison made between a signal voltage value of the signal processed with the set first or second gain and a second voltage value by the comparator.

2. The method for driving a photoelectric conversion apparatus according to claim 1, wherein the gradient of the ramp signal is set to a first gradient or a second gradient different from the first gradient.

3. The method for driving a photoelectric conversion apparatus according to claim 2, further comprising, after the setting of the gradient, converting the signal processed with the first or second gain into a digital signal based on a third result of comparison made between the signal processed with the first or second gain and the ramp signal having the first or second gradient, the signal processed with the first or second gain being an analog signal.

4. The method for driving a photoelectric conversion apparatus according to claim 2, further comprising, before the setting of the gain, converting the signal processed with the first gain into a digital signal based on a fourth result of comparison made between the signal processed with the first gain and the ramp signal having the first or second gradient, the signal processed with the first gain being an analog signal.

5. The method for driving a photoelectric conversion apparatus according to claim 1, wherein the first gain is higher than the second gain.

6. The method for driving a photoelectric conversion apparatus according to claim 1, wherein the first gain is maintained and set based on the first result.

7. The method for driving a photoelectric conversion apparatus according to claim 1,
wherein an operation for transferring a charge from a photoelectric conversion unit of the at least one pixel is performed at a plurality of timings, and
wherein the setting of the gain and the setting of the gradient are both performed between two consecutive ones of the plurality of timings.

8. The method for driving a photoelectric conversion apparatus according to claim 3,
wherein an operation for transferring a charge from a photoelectric conversion unit of the at least one pixel is performed at a plurality of timings, and
wherein the setting of the gain, the setting of gradient, and the converting into the digital signal are performed between two consecutive ones of the plurality of timings.

9. The method for driving a photoelectric conversion apparatus according to claim 1, wherein the first voltage value is greater than the second voltage value.

10. The method for driving a photoelectric conversion apparatus according to claim 2, wherein the first voltage value is set based on a maximum input range of analog-to-digital (AD) conversion performed by the comparator, and the second voltage value is set based on the first and second gradients.

11. The method for driving a photoelectric conversion apparatus according to claim 3, wherein the digital signal is corrected using a ratio of the first and second gains and a ratio of the first and second gradients.

12. The method for driving a photoelectric conversion apparatus according to claim 1,
wherein the photoelectric conversion apparatus includes a ramp signal output circuit configured to output the ramp signal, and
wherein the ramp signal output circuit is configured to output the first voltage value and the second voltage value.

13. The method for driving a photoelectric conversion apparatus according to claim 1,
wherein the at least one pixel comprises a plurality of pixels,
wherein the plurality of pixels is arranged in a matrix of rows and columns, and
wherein each of column circuits disposed for a corresponding column of the columns includes a memory configured to store a result of comparison by the comparator, a gain switch circuit configured to switch the plurality of gains for the gain setting circuit, a ramp signal switch circuit configured to switch the gradient of the ramp signal, and at least one selection circuit configured to control the gain switch circuit and the ramp signal switch circuit.

14. The method for driving a photoelectric conversion apparatus according to claim 13,
wherein the at least one selectin circuit comprises a plurality of selection circuits,
wherein each of the column circuits includes the plurality of selection circuits, and
wherein one of the selection circuits is configured to output a signal to the gain switch circuit, and another of the selection circuits is configured to output a signal to the ramp signal switch circuit.

15. The method for driving a photoelectric conversion apparatus according to claim 1, wherein the at least one pixel includes the gain setting circuit.

16. The method for driving a photoelectric conversion apparatus according to claim 1, wherein the gain setting circuit is an amplification circuit or an attenuation circuit.

17. The method for driving a photoelectric conversion apparatus according to claim 1,
wherein the at least one pixel includes a microlens, a first photoelectric conversion unit, and a second photoelectric conversion unit, and
wherein the setting of the gain and the setting of the gradient are performed using a pixel signal output from the first photoelectric conversion unit, and the setting of the gradient is performed using a pixel signal output from the second photoelectric conversion unit, to detect a phase difference.

18. The method for driving a photoelectric conversion apparatus according to claim 17,
wherein an operation for resetting the comparator is performed at a plurality of timings, and
wherein the setting of the gain and the setting of the gradient are performed using the pixel signal output from the first photoelectric conversion unit, and the setting of the gradient is performed using the pixel signals output from the first and second photoelectric conversion units, between two consecutive ones of the plurality of timings.

19. A photoelectric conversion apparatus comprising:
a pixel configured to generate a pixel signal by photoelectric conversion;
a gain setting circuit configured to process the pixel signal output from the pixel with a plurality of gains;
a comparator configured to compare a signal output from the gain setting circuit and a ramp signal;
a gain switch circuit configured to set a gain of the plurality of gains to a first gain or a second gain different from the first gain based on a first result of comparison made between a signal voltage value of the signal processed with the first gain and a first voltage value by the comparator; and
a ramp signal switch circuit configured to set a gradient of the ramp signal based on a second result of comparison made between a signal voltage value of the signal processed with the first or second gain set by the gain switch circuit and a second voltage value by the comparator.

20. A device comprising:
the photoelectric conversion apparatus according to claim 19; and
at least one of the following:
an optical apparatus configured to guide light to the photoelectric conversion apparatus,
a control apparatus configured to control the photoelectric conversion apparatus,
a processing apparatus configured to process a signal output from the photoelectric conversion apparatus,
a display apparatus configured to display information obtained by the photoelectric conversion apparatus,
a storage apparatus configured to store the information obtained by the photoelectric conversion apparatus, and
a mechanical apparatus configured to operate based on the information obtained by the photoelectric conversion apparatus.
